(19) United States
(12) Patent Application Publication
(10) Pub. No.: US 2016/0253325 A1
(43) Pub. Date: Sep. 1, 2016

(54) METHOD AND APPARATUS FOR PROGRAMMATICALLY ADJUSTING THE RELATIVE IMPORTANCE OF CONTENT DATA AS BEHAVIORAL DATA CHANGES

(71) Applicant: Socialtopias, LLC, Charlotte, NC (US)

(72) Inventors: Todd McKay Morley, Woodland Park, CO (US); Christopher Andrew Provan, Springfield, VA (US); Louis Rudolph Gragnani, III, Waxhaw, NC (US)

(21) Appl. No.: 14/984,356

(22) Filed: Dec. 30, 2015

Related U.S. Application Data
(60) Provisional application No. 62/098,117, filed on Dec. 30, 2014.

(51) Int. Cl. G06F 17/30; G06Q 30/02; G06N 99/00

(52) U.S. Cl. CPC G06F 17/3053; G06F 17/30867; G06N 99/005; G06Q 30/0242

(57) ABSTRACT

Methods, apparatuses, and computer program products are described herein that are configured for creating a hybrid recommendation algorithm that programmatically decreases the importance of the content-based data as the basis of affinity data supporting collaborative filtering grows over time. One example embodiment may include a method for computing a content based similarity metric between a first item and a second item, accessing each of one or more instances of affinity data; and calculating an overall similarity metric between the first item and the second item, the overall similarity metric being a function of the content based similarity metric between the first item and the second item and a number of instances of empirical data for the items, the function defined such that as the number of instances of empirical data increases, the overall similarity metric increases a relative contribution in favor of the empirical data.

### CROSS REFERENCES TO RELATED APPLICATIONS

This application claims the benefit of U.S. Provisional Patent Application No. 62/098,117, filed on Dec. 30, 2014, the entire contents of which are incorporated herein by reference.

### TECHNOLOGICAL FIELD

Embodiments of the present invention relate generally to a method, apparatus, and computer program product for programmatically increasing the relative importance of behavioral data as the behavioral data becomes available when computing similarity measurements in providing a recommendation.

### BACKGROUND

An important class of machine-learning algorithms having very broad application is recommendation engines. Recommendation engines take as input the historical preferences of a class of users for a class of items, and estimate the same users' preferences for items in the same class, where a given user has not yet expressed a preference for a given item. Recommendation engines have proven especially useful on Internet sites that offer to consumers such a large set of items that it would be practically impossible for a given consumer to determine manually which of the items the consumer preferred. In such cases the recommendation engine can infer from the preferences of similar consumers, or from consumers preferences for similar items, which items the target consumer is likely to prefer, and the Internet site can draw the target consumer's attention to these items. For example, in one embodiment a social-networking Web site can recommend to a target consumer socially relevant businesses, products, and services that the consumer is likely to purchase.

While current services may provide search functionality enabling search results to be provided in response to a search request, and even may provide functionality for providing advertisements tailored to an individual, the algorithms fail to account for changing quantity and intensity of their components. In other words, where current services attempt to use hybrid systems combining content based systems with collaborative filtering to provide recommendations, these current services assign a fixed importance to each of its components and fail to account for a changing quantity and intensity of each component.

Example embodiments of the invention described herein include a method of solving a problem that occurs when traditional hybrid recommendation algorithms attempt to address a cold-start problem. In some examples, the cold-start problem occurs when the CF engine is required to produce a recommendation for a given end user, and either lacks sufficient data describing that end user's preferences, or lacks sufficient data describing similar, potentially similar, end users' preferences, to compute the recommendation. A cold-start problem similarly occurs when a new item, destination, location or the like is added. The existing approaches for creating such hybrid models that assign a fixed importance or contribution to each of its components are undesirable, because such a model does not allow the model to account for variation in the quantity and intensity of behavioral evidence supporting the CF model. Ideally a hybrid model would give more weight to such evidence, as the quantity and/or intensity of evidence increases.

### BRIEF SUMMARY

In some embodiments herein, an apparatus, method, and computer program product may be provided for creating a hybrid recommendation algorithm that programmatically decreases the importance of the content-based data as the basis of affinity data for collaborative filtering grows over time. One example embodiment may be a method for estimating the similarity of two items. The method may include a method for computing a content-based similarity metric between the two items, and combining it with a traditional collaborative-filtering similarity metric for the two items. The overall similarity metric would weigh the traditional collaborative-filtering metric according to the number and intensity of instances of empirically derived user preferences for the two items, such that as the number and intensity of these preferences increases, the weight given to these preferences also increases, relative to the weight given to the content-based similarity metric. For example, if the two items are businesses, the content-based data may include a fixed set of firmographic variables, while the preference data may indicate users' affinities for businesses. Another example embodiment may include a method for computing a content-based similarity metric between two users. For example, this embodiment might use a fixed set of socio-demographic variables as content-based variables, while the preference data may indicate users' affinities for items (such as businesses, products, or services).

Furthermore, in some embodiments herein, an apparatus, method, and computer program product may be provided. In some embodiments, a method may be provided for combining collaborative filtering with content-based data thereby creating a hybrid recommendation algorithm that programmatically decreases the importance of the content-based data as the basis of behavioral data for collaborative filtering grows over time, the method comprising computing a content based similarity metric between a first item and a second item, the content based similarity metric computer using a first keyword set associated with the first item and a second keyword set associated with the second item, accessing each of one or more instances of behavioral data, and calculating an overall similarity metric between the first item and the second item, the overall similarity metric being a function of the content based similarity metric between the first item and the second item, a number of instances of known behavioral data for the first item, and a number of instances of known behavioral data for the second item, the function defined such that a contribution of the content based similarity metric having a fixed maximum, and as the number of known instances of behavioral data for the first item or the number of instances of known behavioral data for second item increases, the overall similarity metric increasing a relative contribution in favor of the known behavioral data.

In some embodiments, the computing of the content based similarity between the first item and the second item is defined as the number of common keywords between keywords associated with first item and keywords associated with the second item divided by the square root of the product of the number of keywords in each item profile. In some embodiments, the overall similarity metric further being a function of a non-negative weight, the non-negative weight being a configurable parameter that can adjust the rate at which the known behavioral data contribution increases relative to the content based similarity metric.

In some embodiments, the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile. In some embodiments, the item is a destination, and the method further comprises defining V_{DN}_{₁} and V_{DN}_{₂} to be a vector of user-destination affinities across each of one or more users in a given set for the first item and the second destination, respectively, and the overall similarity metric is calculated according to

$$sim ( {DN}_{1} , {DN}_{2} ) = \frac{\begin{matrix}{W}_{f} ( {sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} ) ) + {V}_{{DN}_{1}} \cdot {V}_{{DN}_{2}}\end{matrix}}{\begin{matrix}\sqrt{3 {W}_{f} + {Σ}_{ST} ( {aff ( ST , {DN}_{1} )}^{2} )} * \\ \sqrt{3 {W}_{f} + {Σ}_{ST} ( {aff ( ST , {DN}_{2} )}^{2} )}\end{matrix}}$$

In some embodiments, the overall similarity metric further being a function of a non-negative weight, the non-negative weight being a configurable parameter that can adjust the rate at which the affinity similarity contribution increases relative to the firmographic similarity.

In some embodiments, the computing of the content based similarity metric is a socio-demographic similarity between a first user and a second user, the content based similarity metric computed as a function of one or more socio-demographic variables.

In some embodiments, the item is an advertisement, the method further comprises defining V_{ST}_{₁} and V_{ST}_{₂} be a vector of user-advertisement click rates across one or more advertisements in a given set for the first user and the second user, respectively, the overall similarity metric is calculated according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{AID} ( {\overline{rate} ( {ST}_{1} , AID )}^{2} )} * \\ \sqrt{{W}_{sd} + {Σ}_{AID} ( {\overline{rate} ( {ST}_{2} , AID )}^{2} )}\end{matrix}} .$$

In some embodiments, the overall similarity metric further being a function of a non-negative weight, the non-negative weight being a configurable parameter that can adjust the rate at which the click rate similarity contribution increases relative to the socio-demographic similarity.

In some embodiments, the item is a destination, the method further comprises defining V_{ST}_{₁} and V_{ST}_{₂} be a vector of user-destination affinities across one or more destinations in a given set for the first user and the second user, respectively, and the overall similarity metric is calculated according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{DN} ( {aff ( {ST}_{1} , DN )}^{2} )} * \\ \sqrt{{W}_{sd} + {Σ}_{DN} ( {aff ( {ST}_{2} , DN )}^{2} )}\end{matrix}} .$$

In some embodiments, an apparatus may be provided for combining collaborative filtering with content-based data thereby creating a hybrid recommendation algorithm that programmatically decreases the importance of the content-based data as the basis of behavioral data for collaborative filtering grows over time, the apparatus comprising a processor including one or more processing devices configured to perform independently or in tandem to execute hard-coded functions or execute software instructions, a user interface, a communications module, and a memory comprising one or more volatile or non-volatile electronic storage devices storing computer-readable instructions configured to programmatically update budgeting data, target consumer profile data, and promotion component data, the computer-readable instructions being configured, when executed, to cause the processor to compute a content based similarity metric between a first item and a second item, the content based similarity metric computer using a first keyword set associated with the first item and a second keyword set associated with the second item, access each of one or more instances of behavioral data, and calculate an overall similarity metric between the first item and the second item, the overall similarity metric being a function of the content based similarity metric between the first item and the second item, a number of instances of known behavioral data for the first item, and a number of instances of known behavioral data for the second item, the function defined such that a contribution of the content based similarity metric having a fixed maximum, and as the number of known instances of behavioral data for the first item or the number of instances of known behavioral data for second item increases, the overall similarity metric increasing a relative contribution in favor of the known behavioral data.

In some embodiments, the computing of the content based similarity between the first item and the second item is defined as the number of common keywords between keywords associated with first item and keywords associated with the second item divided by the square root of the product of the number of keywords in each item profile.

In some embodiments, the overall similarity metric further being a function of a non-negative weight, the non-negative weight being a configurable parameter that can adjust the rate at which the known behavioral data contribution increases relative to the content based similarity metric.

In some embodiments, the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile.

In some embodiments, the item is a destination, and wherein the memory stores computer-readable instructions that, when executed, cause the processor to define V_{DN}_{₁} and V_{DN}_{₂} to be a vector of user-destination affinities across each of one or more users in a given set for the first item and the second destination, respectively, and calculate the overall similarity metric according to

$$sim ( {DN}_{1} , {DN}_{2} ) = \frac{\begin{matrix}{W}_{f} ( {sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} ) ) + {V}_{{DN}_{1}} \cdot {V}_{{DN}_{2}}\end{matrix}}{\begin{matrix}\sqrt{3 {W}_{f} + {Σ}_{ST} ( {aff ( ST , {DN}_{1} )}^{2} )} * \\ \sqrt{3 {W}_{f} + {Σ}_{ST} ( {aff ( ST , {DN}_{2} )}^{2} )}\end{matrix}}$$

In some embodiments, the overall similarity metric further being a function of a non-negative weight, the non-negative weight being a configurable parameter that can adjust the rate at which the affinity similarity contribution increases relative to the firmographic similarity.

In some embodiments, the computing of the content based similarity metric is a socio-demographic similarity between a first user and a second user, the content based similarity metric computed as a function of one or more socio-demographic variables.

In some embodiments, the item is an advertisement, wherein the memory stores computer-readable instructions that, when executed, cause the processor to define V_{ST}_{₁} and V_{ST}_{₂} be a vector of user-advertisement click rates across one or more advertisements in a given set for the first user and the second user, respectively, calculate the overall similarity metric according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{AID} ( {\overline{rate} ( {ST}_{1} , AID )}^{2} )} * \\ \sqrt{{W}_{sd} + {Σ}_{AID} ( {\overline{rate} ( {ST}_{2} , AID )}^{2} )}\end{matrix}} .$$

In some embodiments, the overall similarity metric further being a function of a non-negative weight, the non-negative weight being a configurable parameter that can adjust the rate at which the click rate similarity contribution increases relative to the socio-demographic similarity.

In some embodiments, the item is a destination, wherein the memory stores computer-readable instructions that, when executed, cause the processor to define V_{ST}_{₁} and V_{ST}_{₂} be a vector of user-destination affinities across one or more destinations in a given set for the first user and the second user, respectively, and calculate the overall similarity metric according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{DN} ( {aff ( {ST}_{1} , DN )}^{2} )} * \\ \sqrt{{W}_{sd} + {Σ}_{DN} ( {aff ( {ST}_{2} , DN )}^{2} )}\end{matrix}} .$$

In some embodiments, a computer program product may be provided configured for combining collaborative filtering with content-based data thereby creating a hybrid recommendation algorithm that programmatically decreases the importance of the content-based data as the basis of behavioral data for collaborative filtering grows over time, the computer program product comprising at least one computer-readable storage medium having computer-executable program code instructions stored therein, the computer-executable program code instructions comprising program code instructions for computing a content based similarity metric between a first item and a second item, the content based similarity metric computer using a first keyword set associated with the first item and a second keyword set associated with the second item, accessing each of one or more instances of behavioral data, and calculating an overall similarity metric between the first item and the second item, the overall similarity metric being a function of the content based similarity metric between the first item and the second item, a number of instances of known behavioral data for the first item, and a number of instances of known behavioral data for the second item, the function defined such that a contribution of the content based similarity metric having a fixed maximum, and as the number of known instances of behavioral data for the first item or the number of instances of known behavioral data for second item increases, the overall similarity metric increasing a relative contribution in favor of the known behavioral data.

In some embodiments, the computer-executable program code instructions further comprise program code instructions for wherein the computing of the content based similarity between the first item and the second item is defined as the number of common keywords between keywords associated with first item and keywords associated with the second item divided by the square root of the product of the number of keywords in each item profile.

In some embodiments, the overall similarity metric further being a function of a non-negative weight, the non-negative weight being a configurable parameter that can adjust the rate at which the known behavioral data contribution increases relative to the content based similarity metric.

In some embodiments, the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile.

In some embodiments, the item is a destination, and wherein the computer-executable program code instructions further comprise program code instructions for defining V_{DN}_{₁} and V_{DN}_{₂} to be a vector of user-destination affinities across each of one or more users in a given set for the first item and the second destination, respectively, and calculating the overall similarity metric according to

$$sim ( {DN}_{1} , {DN}_{2} ) = \frac{\begin{matrix}{W}_{f} ( {sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} ) ) + {V}_{{DN}_{1}} \cdot {V}_{{DN}_{2}}\end{matrix}}{\begin{matrix}\sqrt{3 {W}_{f} + {Σ}_{ST} ( {aff ( ST , {DN}_{1} )}^{2} )} * \\ \sqrt{3 {W}_{f} + {Σ}_{ST} ( {aff ( ST , {DN}_{2} )}^{2} )}\end{matrix}}$$

In some embodiments, the overall similarity metric further being a function of a non-negative weight, the non-negative weight being a configurable parameter that can adjust the rate at which the affinity similarity contribution increases relative to the firmographic similarity.

In some embodiments, the computing of the content based similarity metric is a socio-demographic similarity between a first user and a second user, the content based similarity metric computed as a function of one or more socio-demographic variables.

In some embodiments, the item is an advertisement, wherein the computer-executable program code instructions further comprise program code instructions for defining V_{ST}_{₁} and V_{ST}_{₂} be a vector of user-advertisement click rates across one or more advertisements in a given set for the first user and the second user, respectively, the overall similarity metric is calculated according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{AID} ( {\overline{rate} ( {ST}_{1} , AID )}^{2} )} * \\ \sqrt{{W}_{sd} + {Σ}_{AID} ( {\overline{rate} ( {ST}_{2} , AID )}^{2} )}\end{matrix}} .$$

In some embodiments, the overall similarity metric further being a function of a non-negative weight, the non-negative weight being a configurable parameter that can adjust the rate at which the click rate similarity contribution increases relative to the socio-demographic similarity.

In some embodiments, the item is a destination, wherein the computer-executable program code instructions further comprise program code instructions for defining V_{ST}_{₁} and V_{ST}_{₂} be a vector of user-destination affinities across one or more destinations in a given set for the first user and the second user, respectively, and calculating the overall similarity metric according to

$$sim ( {ST}_{1} , {ST}_{2} ) = \frac{{W}_{sd} {sim}_{sd} ( {ST}_{1} , {ST}_{2} ) + {V}_{ST 1} \cdot {V}_{ST 2}}{\begin{matrix}\sqrt{{W}_{sd} + {Σ}_{DN} ( {aff ( {ST}_{1} , DN )}^{2} )} * \\ \sqrt{{W}_{sd} + {Σ}_{DN} ( {aff ( {ST}_{2} , DN )}^{2} )}\end{matrix}} .$$

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of a social media environment that may benefit from some example embodiments of the present invention;

FIGS. 2A and 2B illustrate example flowcharts that may be performed by an item-based collaborative filtering module in accordance with some example embodiments of the present invention;

FIGS. 3A and 3B illustrate example flowcharts that may be performed by a user-based collaborative filtering module in accordance with some example embodiments of the present invention;

FIGS. 4A and 4B illustrate example flowcharts that may be performed by a global average module in accordance with some example embodiments of the present invention;

FIG. 5 illustrate an example flowchart that may be performed by a recommendation module in accordance with some example embodiments of the present invention;

FIG. 6 illustrates an example flowchart that may be performed by a recommendation module in accordance with some example embodiments of the present invention; and

FIG. 7 illustrates a block diagram of an apparatus that embodies a recommendation module in accordance with some example embodiments of the present invention.

### DETAILED DESCRIPTION

Example embodiments will now be described more fully hereinafter with reference to the accompanying drawings, in which some, but not all, embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

### OVERVIEW

An apparatus, method, and computer program product described herein by way of a plurality of example embodiments is an apparatus, method, and computer program product configured to solve the problem of computing the importance that a hybrid recommendation algorithm assigns to each of its component models. In other words, an example method herein may be configured to, programmatically and in real-time, account for variation in the quantity of evidence, such as affinity (or preference) data, supporting the collaborative filtering model, such that the hybrid recommendation method gives more weight to the affinity data supporting the collaborative filtering model as the quantity and intensity of the evidence increase.

Accordingly, methods, apparatuses, and computer program products are described herein that are configured for creating a hybrid recommendation algorithm that programmatically decreases the importance of the content-based data as the basis of affinity data for collaborative filtering grows over time. One example embodiment may include a method for computing a content based similarity metric between a first item and a second item, accessing each of one or more instances of behavioral data; and calculating an overall similarity metric between the first item and the second item, the overall similarity metric being a function of the content based similarity metric between the first item and the second item and a number of instances of known behavioral data for the items, the function defined such that as the number of known instances of behavioral data increases, the overall similarity metric increases a relative contribution in favor of the known behavioral data

### DEFINITIONS

An affinity is an ordinal real number in an interval, e.g., [−1, 1], reflecting a user's degree of preference for, or aversion to, an item such as a destination, product, or service. As is described herein, affinity can be split into at least three types of affinities, namely expressed affinity, computed affinity, and/or inferred infinity. Expressed and computed affinities constitute empirical affinities, those derived directly from behavioral data relevant to estimating a user's preferences.

An expressed affinity is an affinity directly expressed by a user for an item. The expression may occur through a computer application's user interface (UI), for example the UI of an Internet social-networking service, whether rendered on a personal computer, tablet computer, mobile phone, etc. The web site may provide functionality enabling users to express affinities in a predefined range, e.g., [1, 10]. In some embodiments, the recommendation engine, discussed below, may be configured to receive an expressed affinity in the predefined range, and center and rescale these values into a fixed interval, e.g., [−1, 1.

A computed affinity is an affinity computed indirectly, based on a user's behavior or interaction with the social networking system, or in other embodiments, other web sites or mobile applications. The interactions may include favorites, follows, and activations (e.g., visits) through the UI. In some embodiments, for a given user and destination, variables I_{fav} and I_{fol} may be defined to be indicator (zero-one) variables indicating whether a user has, respectively, favorited and followed a destination. In some embodiments, variable A may take the form of a nonnegative-integer variable configured for counting how many activations the user has had at the destination in a time period (e.g., the most recent time period may be used). Further, variables W_{fav} and W_{fol} indicative of weights, may be included in determine a computed affinity in some examples. Each of these weights may be in a predefined range, e.g., [0, 1], as may be their sum. Finally, variable Cₐ may be a non-negative constant. Then the computed affinity may be calculated as:

W_{fav}*I_{fav}+W_{fol}*I_{fol}+(1−W_{fav}−W_{fol})*(A/(Cₐ+A)

Thus, in an exemplary embodiment, any favoriting, following, or activation data may yield a computed affinity above the mean, that is, in the interval [0, 1]. In other words, in this exemplary embodiment, favoriting, following, or activation types of data indicate a degree of positive affinity.

Empirical affinity may be defined as the union of the sets of expressed and computed affinities. This will be further described below.

An inferred affinity is an affinity estimated by, for example, a recommendation module, using item or user-based collaborate filtering, for users in the data set. For new users not yet in the data set, global averages of empirical affinities may be utilized for calculating the inferred affinity.

In some embodiments, one of, for example, five methods may be provided for determining a user's affinity for an item: (1) expressed affinity; (2) computed affinity; (3) item-based CF; (4) user-based CF; and (5) global averages. The method may depend on what kind of evidence is available. In some embodiments, the above list may be in descending order of preference where more precise methods are preferred. Thus a recommendation module may be configured to first use expressed affinities where they exist; otherwise computed affinities where likes, follows, or activations exist; otherwise item-based CF where sufficient data exists; otherwise user-based CF; and otherwise global averages.

Content-based item attributes or simply content-based data, as referred to herein, may be information indicative of one or more characteristics of items that a recommendation engine may use to assess item similarity. For example, firmographic variables such as product type and price range characterize social destinations such as restaurants.

Sociodemographic user attributes, as referred to herein, may be information indicative of one or more characteristics of users, that a recommendation engine may use to assess user similarity. For example, variables such as age, gender, and personal income characterize social-network users.

### Technical Underpinnings and Implementation of Exemplary Embodiments

While providers of recommendation engines exist in may diverse industries, each recommendation engine may face many of the same or similar problems. One such problem that each may face is that of a “cold start”. Specifically, recommendation engines may face three kinds of cold-start problems. First, an engine may have no affinity data for a new user (e.g., the user cold-start problem). Second, an engine may have no affinity data for a new item (e.g., the item cold-start problem). Third, an engine may have very little total affinity data (e.g., the system cold-start problem). In response, providers of such engines have spent a tremendous amount of time, money, manpower, and other resources in determining methods to solve the cold start problem by, for example, acquiring and utilizing affinity data.

General solutions to these problems usually involve hybrid engine architectures. To date, such architectures have mostly combined a single CF architecture with a single content-based architecture, where content-based attributes function as a surrogate for known affinities. Such approaches generally improve on single-architecture CF models, but fail to account for much of the available information, or to weigh different sources and kinds of information appropriately.

The present invention reaches beyond traditional hybrid models by combining five recommendation architectures—a behavioral model (empirical affinities, that is, expressed and computed affinities), two CF models (user and item based CF models using empirical affinities as their inputs), and two content-based models (user and item attributes). Moreover, the present invention combines CF and content-based models in a novel way that always uses content-based data to the degree that empirical affinity data do not overshadow the former.

In the context of social networking services, the result is a set of recommendation engines that produce item recommendations (such as destination and advertisement recommendations) based on all available information, including user attributes (sociodemographic variables), item attributes (such as firmographics for commercial destinations), and behavioral data (such as users' expressed affinities; text-search terms; likes, follows, and activations for destinations; and “click throughs” for previous advertisements produced by a given destination). By using all available information to recommend e.g., a social destination in the physical world, recommendation engines, in the context of a social networking service, may maximize the probability that each interaction between a user and a social networking service user interface in the virtual world will result in a positive social experience for the end user in the physical world. As such, programmatically providing functionality enabling provision of a recommendation of an item in response to a recommendation request by programmatically synthesizing multiple sources of data is a complex and difficult technological challenge to overcome for the provider of a recommendation engine.

In many cases, the inventors have determined that providers of recommendation engines, such as those related to social network services or medical industries, are constrained by technological obstacles unique to the electronic nature of the services provided, such as constraints on data storage, machine communication and processor resources. For example, a provider of a recommendation engine must continuously capture, maintain, and calculate information (e.g., expressed and computed affinities, (user, item, affinity) triples, etc.) that is up-to-date and accurate as well as provide, maintain, and add functionality that enables users to provide utilize the recommendation engine.

One specific problem unique to the electronic nature of the services provided is building and maintaining the technical infrastructure and user infrastructure. In an exemplary social networking context for example, the technical infrastructure being necessary to enable a robust social network and the user infrastructure being necessary for the mass of individual users necessary to provide a social network service. For example, a social network service must have many users, enough users to form social networks around various offerings, such as destinations, events, families, friends, and interests. To do this a social network service must provide the technical infrastructure such as individual profile pages, chat functionality, the ability to form and participate in groups, entourages, etc. Once the basics of social networks are met, the digital medium allows the mass of individuals to grow without geographic restriction. However, data must continuously be captured, stored, and verified. Each of the many functionalities must be maintained and updated as their use grows and new platforms are utilized.

Another specific problem unique to the electronic nature of the services provided herein arises in the provision and performance of the services on multiple devices. Users access social networks from laptops, tablets, cellular phones, and “phablets” these days.). Thus the social network service providers must be able to provide functionality, including the coding, maintaining, updating, and migrating of each functionality, on each device.

Finally, given the volume of electronic post data and the volume of related data, such as advertisement data, social networks often provide imperfect or irrelevant information to a user or are unable to provide specific information, notably when a user or the information, such as a product, service, or ad, is new. This problem is not found in the physical world as users are more able to filter content, such as by navigating a newspaper or selecting a news program. In social networks, no such filter is available.

In response to these problems and other problems, the inventors have identified methods and apparatuses for providing functionality for providing a recommendation of an item (e.g., destination, advertisement, event, etc.) in response to a recommendation request by programmatically synthesizing all available sources of data that is unlike current technologic functionality offered by social network services or elsewhere so as to encourage user consumption of the offered item, for example attendance at a destination, event, etc.). That is, embodiments of the present invention as described herein serve to offer improved services such as programmatically synthesizing each of a plurality of sources of data bearing on user preferences for selecting an item to recommend and providing a recommendation of the item. The concept of combining global averages, user-based CF, item-based CF, behavioral modeling, expressed preferences, and content-based (e.g., socio-demographic and firmographic) recommendations into a single hybrid recommender distinguishes the system and method described herein.

Furthermore, in response to these problems and other problems, the inventors have identified methods and apparatuses for providing functionality combining traditional collaborative filtering with content-based data, thereby creating a hybrid recommendation algorithm that programmatically diminishes the importance of the content-based data, as the basis of affinity data for collaborative filtering increases that is unlike current technologic functionality offered in social networks. That is, embodiments of the present invention as described herein serve to offer improved services such as programmatically decreasing the relative importance of the content-based data, as affinity data that may be used for collaborative filtering increases, thus providing improvements to services that address problems arising out of the electronic nature of those services. The concept of accounting for variation, or relative disproportion, in the quantity and intensity of affinity or preference data supporting a collaborative filtering model that, for example, gives more weight to evidence, as the quantity and intensity of that evidence is increased distinguishes the system and method described herein.

For example, the programmatic decreasing of the relative importance of the content-based data, as affinity data that may be used for collaborative filtering increases enables the present invention to provide better recommendations as more behavior data is received. As such, services using the recommendation engine may use this information to, programmatically and in real-time, account for variation in the quantity and intensity of affinity data supporting the CF model. That is, ideally a hybrid model would give more weight to such of behavioral evidence supporting the CF model, as the quantity and intensity of the evidence increases. For example, a social network service may programmatically and in real time provide and/or display more relevant material using the recommendation engine described herein.

Methods, apparatuses, and computer program products of example embodiments of the present invention may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile terminals, such as a portable digital assistant (PDA), mobile telephone, smartphone, laptop computer, tablet computer, or any combination of the aforementioned devices.

### Exemplary Block Diagram of the System

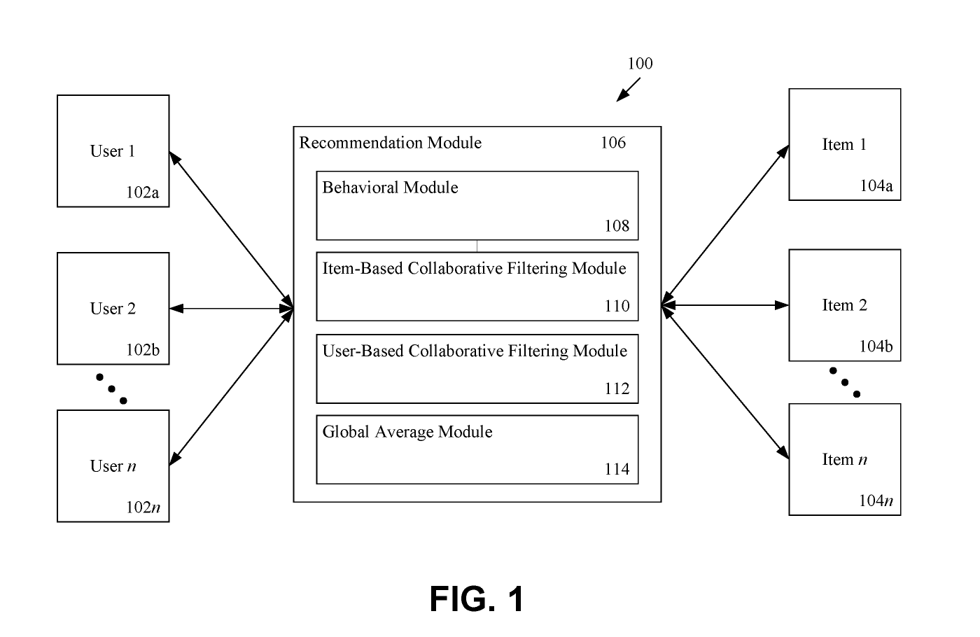

FIG. 1 is an example block diagram of example components of an example social media environment 100. In some example embodiments, the social media environment 100 comprises one or more users 102a-102n, one or more items (e.g., destinations (e.g., establishments, businesses), advertisements, entertainers, promoters, etc.) 104a-104n, and/or a recommendation module 106. The recommendation module 106 may take the form of, for example, a code module, a component, circuitry and/or the like. The components of the example social media environment 100 are configured to provide various logic (e.g., code, instructions, functions, routines and/or the like) and/or services related to the recommendation module 106 and its components.

In some embodiments, the item-based collaborative filtering module 110 may be configured to be used when a number of user-to-item pairings meet a predetermined threshold. For example, in one use embodiment, recommendation module 106 may be configured to be a destination recommendation module, and the item-based collaborative filtering module 110 may be configured to be used in or called by the recommendation module, when a user (e.g., one of the one or more users 102a-102n) has known interactions with at least N Destinations (e.g., one or more items 104a-104n), N being a configurable parameter. Furthermore, in some embodiments, recommendation module 106 may be configured to be an advertisement recommendation module, and the item-based collaborative filtering module 110 may be configured to be used in or called by the advertisement recommendation module when a user (e.g., one of the one or more users 102a-102n) has recorded clicks on at least N different Advertisements, again N is a configurable parameter.

In some embodiments, the user-based collaborative filtering module 112 may be configured to be used when a number of user-to-item pairings fails to meet a predetermined threshold. For example, in one use embodiment, recommendation module 106 may be configured to be a destination recommendation module, the user-based collaborative filtering module 112 may be configured to be used in or called by the destination recommendation module when a user (e.g., one of the one or more users 102a-102n) has less than N empirical affinities, the user-based recommender may be used to predict unknown affinities, N is a configurable parameter. Furthermore, in some embodiments, recommendation module 106 may be configured to be an advertisement destination recommendation module, the item-based collaborative filtering module 110 may be configured to be used in or called by the advertisement recommendation module when a user (e.g., one of the one or more users 102a-102n) clicks on less than N advertisements, the user-based recommendation model may be used to predict unknown click rates, again N is a configurable parameter.

The prediction of unknown affinities as used herein comprises the ordering of items (e.g., destinations and advertisements), in descending order of predicted affinity. In other words, affinity, such as the affinity of a user for a destination or advertisement, is an ordinal concept; and, as such, may be used to rank items. In some embodiments, the magnitude has no absolute meaning. In particular, the magnitude is not a probability or a rate.

In some embodiments, the global average module 114 is configured to be used only in the case of new users (e.g., one or more of the one or more users 102a-102n) that have registered on the site since the last batch collaborative filtering run and therefore will not receive user-specific predictions until a next batch run of the algorithm. In some examples, the global average module 114 may be used in an instance in which new destinations, advertisements, events, experiences or the like are added.

### Exemplary Processes for Implementing Embodiments of the Present Invention

In some embodiments, recommendation module 106 may be configured or otherwise embodied as a destination recommendation module, to provide or otherwise output destination recommendations. The destination recommendation module may be configured to generate user-specific rankings of destinations based on known and/or inferred preferences (“affinities”). As described above, known affinities may be computed as a function of known user interactions with a destination, for example, within the social network service or environment. In some embodiments, the social network service may provide functionality for rating a destination, setting a destination as a favorite, following a destination, accepting/executing a discount offered by a destination, activating at a destination, or the like, each of which may be configured to factor into any output destination recommendations.

In some embodiments, recommendation module 106, and in particular the destination recommendation model that may be stored, executed, or provided therein, may be comprised of one or more, but in some examples four independent recommendation models. In some embodiments, the behavioral model 108 may be used when expressed or computer affinities are available. The behavioral model 108 may be configured to combine the expressed and computed into a single class of empirical (behavioral) affinities. The output of the behavioral model 108 may be configured to serve as input(s) to the one or more of the CF and global-average models. In some embodiments, two models, the item-based CF model and the user-based CF model, may be configured for predicting preference of, calculating or otherwise determining unknown affinities for a given user, the choice of which may depend on the amount of known affinity data available for the user. The third model, the global average model, may be a degenerate case of user-based CF, where a “neighborhood” of users “similar” to the target user may be the entire user population, and where degree of similarity is not used to weigh the population's empirical affinities. This model may be configured to be used depending on how recently the user registered.

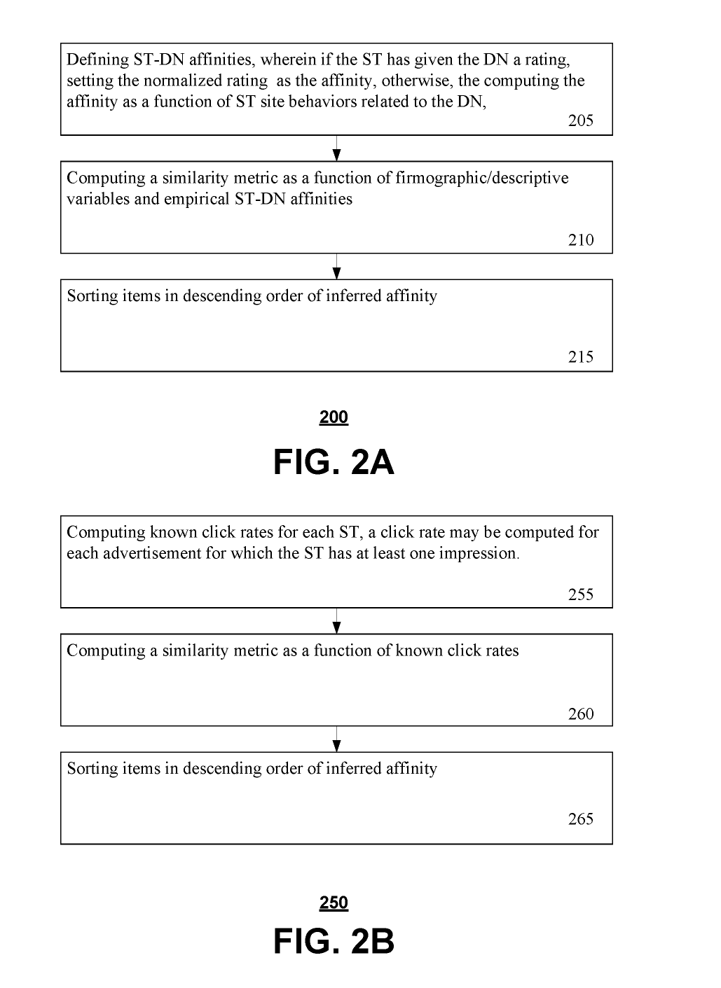

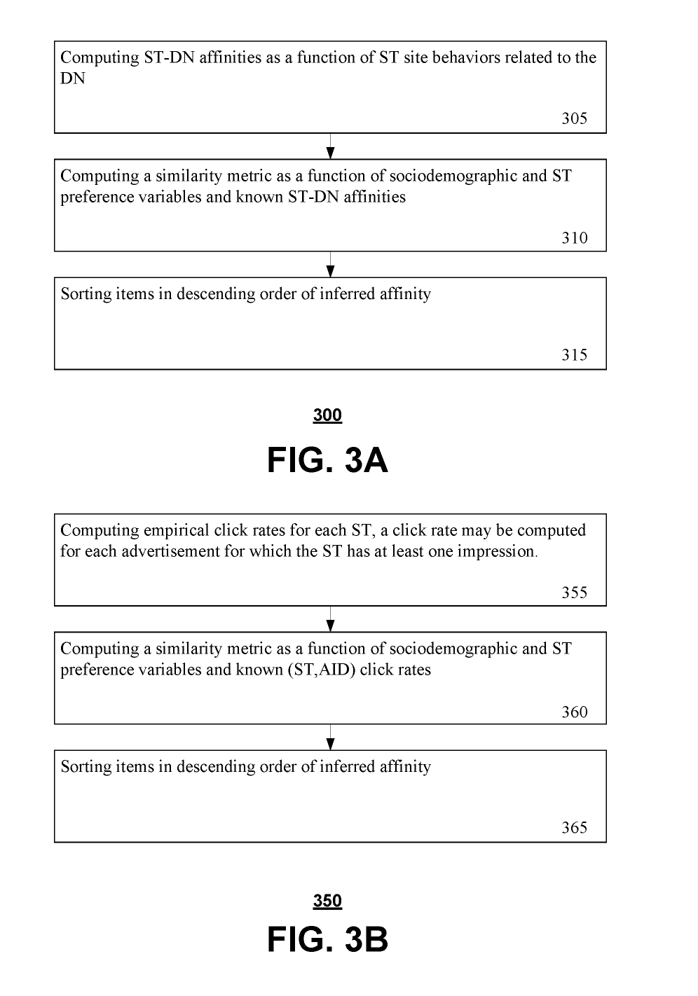

As will be described further in FIG. 2A, the recommendation module 106 may comprise an item-based collaborative filtering model 110. The item-based collaborative filtering model 110 may be used when a user has known interactions with at least N destinations, N being a configurable parameter. The recommendation module 106 may further be configured to comprise a user-based collaborative filtering model 112, which will be described in FIG. 3A. For a user with less than N empirical destination affinities, the user-based recommendation model 112 may be used to predict unknown affinities.

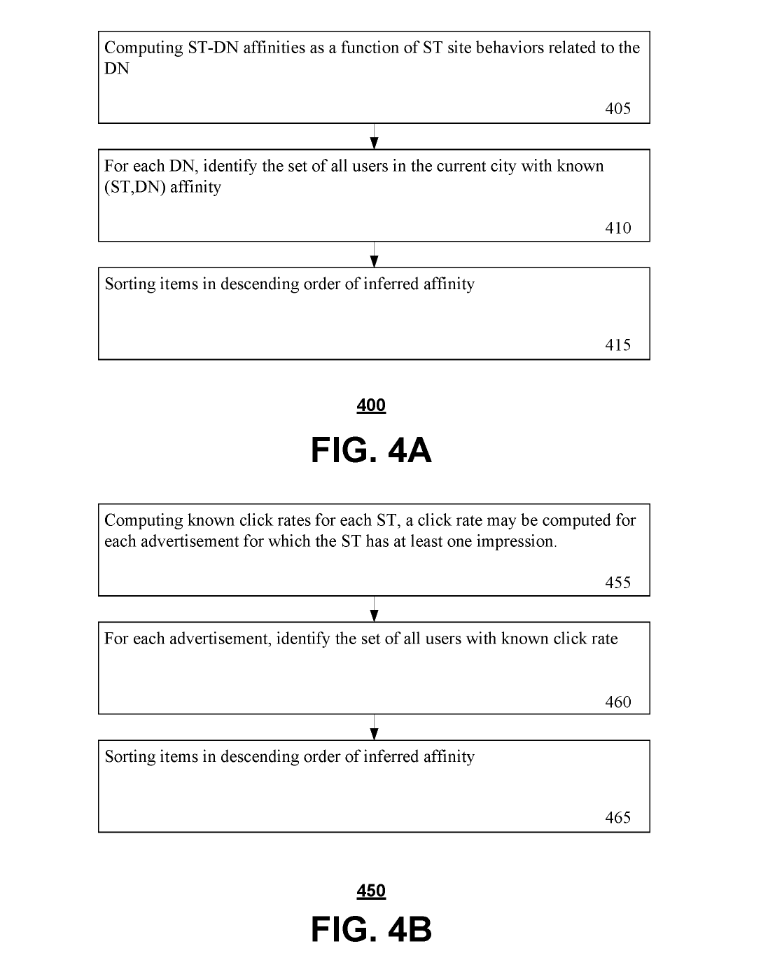

The item-based collaborative filtering model 110 may be utilized to addresses system user-specific “cold starts” in which new users do not have enough known ratings to generate meaningful recommendations using the item-based collaborative filtering model 110. In some embodiments, if the number of empirical affinities for a given destination is less than a predefined threshold, the recommendation model 106 may utilize a distance metric configured to shift weight from content evidence to affinity evidence, to the degree the quantity of affinity evidence overshadows the quantity of content evidence. The recommendation module 106 may further be configured to comprise a global average model, which will be described in FIG. 4A. The global average module 114 may be used in instances in which a new user (e.g., a user that has registered on the site since, for example, the last batch collaborative filtering run and as such will not receive user-specific predictions until the next batch run of the algorithm) is provided.

In some embodiments, recommendation module 106 may be configured as an advertisement recommendation module, and further be configured to provide or otherwise output advertisement (or ‘ad’) recommendations. The advertisement recommendation module may be configured to generate user-specific rankings of ads to be shown to users based on empirical affinities for the advertisements, such as the number of impressions until the first click or, in some embodiments, the ratio of clicks to impressions). In some embodiments, when the system requests a ranking of candidate ads for a given location on, for example, the site for a specified user, the advertisement recommendation module may return a sorting based on the overall ad ranking for that user.

In some embodiments, recommendation module 106, and in particular the advertisement recommendation model that may be stored, executed, or otherwise provided therein, may be comprised of one or more, but preferably four recommendation models. In some embodiments, the behavioral model may be used when expressed or computer click rates are available and the results may be used when available as the click rates (direct evidence). The output of the behavioral model may be configured to serve as input to the one or more of the CF and global-average models. In some embodiments, the item-based CF model and the user-based CF model, may be configured for ranking unknown click rates, the model used to rank unknown click rates for a given user depending on the amount of known user click data that is available, and another used based on how recently the user registered. The third model, the global average model, may be a degenerate case of user-based CF, where a “neighborhood” of users “similar” to the target user may be the entire user population, and where degree of similarity is not used to weigh the population's empirical affinities. This model may be configured for use with a new user.

As will be described further with reference to FIG. 2B, the recommendation module 106 may comprise an item-based collaborative filtering model 110. In some embodiments, the item-based collaborative filtering model 110 may be configured for use when a user has recorded clicks on at least N different advertisements, (e.g., a known click rate can be determined), N being a configurable parameter. The recommendation module 106 may further be configured to comprise a user-based collaborative filtering model, which will be described in FIG. 3B. The user-based collaborative filtering model 112 may be configured for use with a user having recorded clicks on less than N advertisements, the user-based recommendation model configured to rank advertisements based on a predicted affinity. The item-based collaborative filtering model 110 may be utilized to addresses system user-specific “cold starts” in which new users do not have enough recorded impressions and clicks to generate meaningful recommendations using the item-based collaborative filtering model 110. The recommendation module 106 may further be configured to comprise a global average model, which will be described in FIG. 4C. The global average model may be configured for use with a new user (e.g., users that have registered on the site since the last batch collaborative filtering run and therefore may not receive user-specific predictions until the next batch run of the algorithm). Note that parameter N is a distinct parameter from the parameter described with reference to the destination recommendation model.

In view of the system described with reference to FIG. 1, FIGS. 2A and 2B show flowcharts illustrating example processes that may be performed by the item-based collaborative filtering module 110 in accordance with some example embodiments of the present invention. FIG. 2A is directed to destination recommendation model embodiment and FIG. 2B is directed to an advertisement recommendation model embodiment of the item-based collaborative filtering module 110.

FIGS. 3A and 3B show flowcharts illustrating example processes that may be performed by user-based collaborative filtering module 112 in accordance with some example embodiments of the present invention. FIG. 3A is directed to destination recommendation model embodiment and FIG. 3B is directed to an advertisement recommendation model embodiment.

FIGS. 4A and 4B show flowcharts illustrating example processes that may be performed by the global average module 114 in accordance with some example embodiments of the present invention. FIG. 4A is directed to destination recommendation embodiment and FIG. 4B is directed to an advertisement recommendation embodiment.

In some embodiments, the models may be partitioned. For example, in a social networking context, there may be a difference between how the advertisement and destination recommendation models use location information or data (e.g., a particular neighborhood or city). That is, in some exemplary embodiments, the destination recommendation module may be configured such that each location may be treated or otherwise utilized effectively as an independent model, each location having a separate, location-specific model. For example, each city may have its own model of user affinities for destinations in the city. The logic may be that a large majority of user-destination interactions are anticipated to occur between users and destinations in the same social city. In contrast, advertisements need not be geographically limited. Thus the advertisement recommendation model may not explicitly partition the model, although, in some embodiments, it may. In some embodiments, for example, the computational demands of the user-based recommendation model described in FIG. 4B may be configured for partitioning to be implemented when the site-wide number of users reaches a threshold.

### Exemplary Embodiments of Item-Based Collaborative Filtering Module

### Item-Based Collaborative Filtering Model for Destinations

### Model Overview

In an item-based collaborative filtering model, a pairwise item (e.g., a destination) similarity may be quantified based on how similar users tend to rate the two items. A sorting of items (destinations, ads, etc.) in descending order of an inferred affinity may then be generated for user-destination pairs with no known interactions based on the user's known affinities for similar items. Hybrid item-based collaborative filtering may follow the same high-level logic but may include content-based variables such as firmographics and content tagging in calculating a similarity metric.

In some embodiments, the item-based recommendation module may require a certain density of known preferences for a user in order to be more effective than user-based recommendation or global averaging. Thus the item-based recommendation module may, in some embodiments, only be used when the user has known affinities for at least N destinations, where N is a configurable model parameter.

The item-based recommendation module may be configured to predict a preference order and/or generate a ranking of items in descending order of an inferred affinity, for all, or some portion of, user-destination pairs in a particular location (e.g., each user city) with an unknown preference where the user meets the minimum known affinity threshold. For each user, the predicted preference order and the known affinities may then be used to generate a user-specific preference ranking over all destinations.

### Model Description

FIG. 2A is a flowchart illustrating an example process that may be performed by the item-based collaborative filtering module 110 in accordance with some example embodiments (e.g., a destination recommendation embodiment) of the present invention. In some embodiments, the item-based collaborative filtering module may be configured as a hybrid item-based collaborative filtering model. The item-based collaborative filtering module may be comprised of one or more, but preferably three sub-models, which are described below. In some examples, the models may include a pair of a user (ST), which is a user of the social network, and a destination (DN).

The first of the three sub-models, the affinity model may define ST-DN affinities. The second of the three sub-models is the destination similarity model which may compute a similarity metric as a function of firmographic/descriptive variables and known ST-DN affinities. The third of the three sub-models is collaborative filtering model proper and uses the destination similarities to generate a ranking, in order of inferred affinity, of ST-DN affinities.

In some embodiments, the collaborative filtering model may be run as a batch job with the frequency of a batch update set as a parameter (e.g., 1-4 times daily in production). The similarity model may, in some embodiments, require affinities, and additionally in some embodiments, firmographic data, as an input, and the collaborative filtering model may, in some embodiments, require both affinities and similarities as inputs. Many of the affinities/similarities are likely to persist between batch runs and may not need to be recomputed. Affinities/similarities that do change can be updated between batch runs either through continuous updating (monitor for triggering events and immediately, or near immediate, recomputed) or in more frequent batch updates between the collaborative filtering batch runs. This may reduce the peak processing load during full batch updates but may increase average processing loads due to some affinity/similarity updates being overwritten by additional updates prior to the next batch run. This tradeoff may be evaluated in the implementation of the model.

### Component Model Specifications

1. Affinity Model

The affinity model may be configured to assign affinities, (e.g., between −1 and 1) for ST-DN pairs in which there are known site interactions. Accordingly, as is shown in operation 205, an apparatus, such as computing system 500, may include means, such as the item-based collaborative filtering module 110, the processor 803, or the like, for defining each of one or more user-destination (ST-DN) affinities. In some embodiments, in an instance in which the ST has given the DN a rating, the rating may be used. In some embodiments, the given rating may be normalized, and the apparatus may then be configured for setting the normalized rating as the affinity. In contrast, in an instance in which the user has not given the destination a rating, the apparatus may be configured to compute an affinity as a function of ST site behaviors related to the DN, such as for example, follows, favorites, activations at destinations, acceptance of deals, etc. That is, in some embodiments, if the ST has, for example, reviewed a particular destination and given it an overall experience rating, the model may assign a normalized rating as the affinity. Otherwise, the model may be configured to process a range of logged ST-DN interactions into a computed affinity that attempts to infer how the ST would rate the DN based on other logged behaviors. ST-DN pairs with no recorded action may be assigned a null affinity to indicate that the preference order will need to be predicted by the collaborative filtering sub-model.

In some embodiments, many of the affinities are likely to remain static between consecutive batch runs. Thus the known affinities may be stored between batches and updated as needed. A (ST,DN) pair may be flagged for update when one of the following interactions occurs between that ST and DN: (1) ST adds/updates rating for DN; (2) ST has not rated the DN; and (3) one of (a) ST adds/removes DN as a favorite; or (b) ST follows/unfollows DN, or (c) ST activates at DN, (d) or ST accepts a deal from DN, or (e) ST activation at DN or acceptance of deal from DN “ages out” (e.g., becomes more than 15 months old).

In some embodiments, affinities for flagged (ST,DN) pairs may be updated continuously by triggering the affinity model when a pair is flagged, or, in some embodiments, the flagged (ST,DN) pairs may be updated in batches. If updated in batches, in some embodiments, the affinity batch updates must occur with at least as much frequency as the collaborative filtering sub-model batch updates.

### Model Formulation

For a given (ST,DN) pair, the affinity aff(ST, DN) may be computed as a function of the known interactions between the ST and DN. There are one or more, but preferably three possible cases:

1) If the ST has not rated, followed, favorited, activated at, or accepted a deal offered by the DN then set aff (ST, DN)=null to indicate that this affinity is unknown and its ranking in a preference order of the items must be predicted by the collaborative filtering model.

2) If the ST has given the DN an overall experience rating of, for example, 1-10 in a review then the affinity may be set to the normalized ST-DN rating. In some embodiments, if r(ST, DN) may be defined as the rating given by User ST to Destination DN and r̅_{ST} as the mean overall experience rating given by ST across all rated destinations. Then set

$$aff ( ST , DN ) = \{ \begin{matrix}\frac{r ( ST , DN ) - {\overline{r}}_{ST}}{10 - {\overline{r}}_{ST}} & if r ( ST , DN ) > {\overline{r}}_{ST} ; \\ \frac{{\overline{r}}_{ST} - r ( ST , DN )}{{\overline{r}}_{ST} - 1} & if r ( ST , DN ) < {\overline{r}}_{ST} ; \\ 0 & if r ( ST , DN ) = {\overline{r}}_{ST} .\end{matrix}$$

Note, in some examples the last case may be explicitly defined to account for the cases where all known user ratings are 10 or all known user ratings are 1.

3) Otherwise, compute the affinity as a function of the known ST-DN interactions. Define, in some examples, the following configurable parameters:
W_{fav}: weight for favorites
W_{fol}: weight for follows (likely that W_{fol}<W_{fav})
Wₐ: weight for activations

where 0<W_{fav}, W_{fol}, Wₐ<1 and W_{fav}+W_{fol}+Wₐ=1.

In some embodiments, the following functions may also defined:

$${x}_{fav} ( ST , DN ) = \{ \begin{matrix}1 & if DN in ST favorites \\ 0 & otherwise\end{matrix} \\ {x}_{fol} ( ST , DN ) = \{ \begin{matrix}1 & if ST following DN \\ 0 & otherwise\end{matrix} \\ {x}_{a} ( ST , DN ) = ( \begin{matrix}count of ST activations at DN and \\ acceptance of deals from DN \\ over preceding 15 months\end{matrix} )$$

Then the ST-DN affinity may be computed as either of the following equations:

$$aff ( ST , DN ) = {W}_{fav} {x}_{fav} ( ST , DN ) + {W}_{fol} {x}_{fol} ( ST , DN ) + {W}_{a} \frac{{x}_{a} ( ST , DN )}{C + {x}_{a} ( ST , DN )}$$

$$aff ( ST , DN ) = {W}_{fav} {x}_{fav} ( ST , DN ) + {W}_{fol} {x}_{fol} ( ST , DN ) + {W}_{a} ( 1 - {e}^{- \frac{5 {x}_{a} ( ST , DN )}{C}} )$$

where C is a configurable constant with a default value, for example 1.5. Different affinity models may be used, and may involve other parameters. In general, the appropriate value for these configuration parameters is whatever value minimizes affinity error. This value can be determined experimentally by parameter estimation over past affinity data. Note that in this exemplary embodiment, the affinity will be in the interval [0,1].

2. Destination Similarity Model

The Destination similarity model may be configured to compute pairwise similarities between Destinations. As is shown in operation 210, an apparatus, such as computing system 500, may include means, such as the item-based collaborative filtering module 110, the processor 803, or the like, for computing a similarity metric. In some embodiments, the similarity metric may be computed as a function of firmographic/descriptive variables and known ST-DN affinities. For example, for each of one or more pairs of destinations, a similarity metric may be computed. Where a user has not given a particular destination a rating, a rating may be inferred based on a rating that the user has given a similar destination.

Similarity may be computed as a modified cosine similarity between the extended firmographic and affinity vectors of the destinations. The model may be constructed in such a way that as the number of known affinities increases for a destination, the relative weight of affinity similarity naturally increases compared to firmographic similarity in the overall similarity computation.

In some embodiments, the item-based filtering model may require that similarities be computed for all DN pairs. In some embodiments, many similarities are likely to remain unchanged between consecutive batch runs of the filtering model. Therefore, the similarities may be stored between batch runs and be computed/recomputed only as required. A DN may be flagged as needing to have its similarities updated if any of the following occur: (1)—The DN is new to the system (i.e., does not have any defined or otherwise inferred similarities); (2)—The categories, tags, or neighborhoods in the DN profile have been updated; (3) One or more (ST,DN) affinities have been updated for this DN.

In some embodiments, when a DN is flagged, the similarities between that DN and all other DNs in the same user city may be recomputed. In some embodiments, similarities are symmetric, (e.g., sim(DN1,DN2)=sim(DN2,DN1)). Thus it is important that recomputed similarities be updated for both pair orderings if they are stored separately.

As in the case of affinities, flagged DNs may be updated continuously by triggering the similarity model immediately when a DN is flagged, or the flagged DNs can be updated in batches. The update frequency may be no more frequent than the affinity update frequency and no less frequent than the collaborative filtering batch frequency in some examples.

### Model Formulation

In some examples, the system may be configured to determine the similarity between two destinations. The similarity between two destinations DN1 and DN2 may be computed as a cosine-like similarity function over a set of pure cosine similarity sub-functions. The similarity may be a real number on the interval, for example, [−1,1] with a higher value indicating greater similarity.

For the firmographic dimensions, the sub-functions are of similar form:

$${sim}_{tags} ( {DN}_{1} , {DN}_{2} ) = \frac{\vert {DN}_{1} profile tags ⋂ {DN}_{2} profile tags \vert}{\sqrt{\vert {DN}_{1} profile tags \vert * \vert {DN}_{2} profile tags \vert}}$$

$${sim}_{cat} ( {DN}_{1} , {DN}_{2} ) = \frac{\vert {DN}_{1} factual categories ⋂ {DN}_{2} factual categories \vert}{\sqrt{\vert {DN}_{1} factual categories \vert * \vert {DN}_{2} factual categories \vert}}$$

$${sim}_{nbd} ( {DN}_{1} , {DN}_{2} ) = \frac{\vert {DN}_{1} neighborhood tags ⋂ {DN}_{2} neighborhood tags \vert}{\sqrt{\vert {DN}_{1} neighborhood tags \vert * \vert {DN}_{2} neighborhood tags \vert}}$$

$$sim ( a , b ) = \frac{\vert a ⋂ b \vert}{\vert a ⋃ b \vert}$$

Here, the vertical bars represent the set size function. Thus the sub-functions may be computed as the number of common tags/categories between DN1 and DN2 divided by the square root of the product of the number of tags in each destination's profile. If either DN does not have any profile tags, factual categories, or neighborhood tags then the denominator will be zero in the corresponding similarity component, and the component ratio will be undefined. In this case, the similarity may be set to zero. As one of ordinary skill would appreciate, other similarity functions may be used. Moreover, regarding design assumptions, note the importance of the form's upper/lower bounds ([−1 to 1] or [0 to 1]) and its algebraic properties (symmetry, monotonicity, intransitivity) because these properties may dictate how often the scores may be recalculated.

The profile tags and neighborhood tags may, in some embodiments, be used directly for the above sub-functions. The factual categories may be expanded. For example, the factual category (Social,Restaurant,Italian) may be expanded into one or more, but preferably three categories:

(Social),(Social,Restaurant),(Social,Restaurant,Italian)

For Destinations with multiple factual categories, any duplicates resulting from the expansion of the categories may be removed. For example, a restaurant with the two categories (Social,Restaurant,Italian) and (Social,Restaurant,Greek) would, after removing duplicates, have expanded categories:

(Social),(Social,Restaurant),(Social,Restaurant,Italian),(Social,Restaurant,Greek)

The expanded factual categories are the basis for computing sim_{cat}( ).

The final similarity measure may be a function of the firmographic similarities defined above and the known affinities across all users for each Destination. V_{DN} may be defined to be the vector of (ST,DN) affinities across all users ST in the city. If the affinity is null (i.e., unknown) then the corresponding element of the vector may be set to zero. The overall similarity function may then be defined to be:

$$sim ( {DN}_{1} , {DN}_{2} ) = \frac{\begin{matrix}{W}_{f} ( {sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} ) ) + {V}_{{DN}_{1}} \cdot {V}_{{DN}_{2}}\end{matrix}}{\begin{matrix}\sqrt{3 {W}_{f} + {\sum }_{ST} ( {aff ( ST , {DN}_{1} )}^{2} )} * \\ \sqrt{3 {W}_{f} + {\sum }_{ST} ( {aff ( ST , {DN}_{2} )}^{2} )}\end{matrix}}$$

where V_{DN}_{₁}·V_{DN}_{₂} may be the dot-product of the rating vectors:

$${V}_{{DN}_{1}} \cdot {V}_{{DN}_{2}} = {\sum }_{ST} ( aff ( ST , {DN}_{1} ) * aff ( ST , {DN}_{2} ) )$$

The above similarity function is similar to a cosine similarity but has been modified to account differently for firmographic and affinity-based components of the similarity. As the number of known affinities grows for DN1 and/or DN2, the length of the affinity vectors and thus the denominator of sim(DN₁, DN₂) will increase. The contribution of the firmographic variables to the numerator has a fixed maximum (each sub-function is between zero and one), and thus the influence of firmographic similarity will decrease as the length of the two vectors increases. This may naturally shift influence from firmographic similarity to affinity similarity as the number of known affinities for a destination increases. Technically, if the known affinities' values are all zero, or if they get smaller at a sufficiently high rate, the convergence this paragraph describes may not occur. It suffices mathematically to assume that a subsequence of known affinities in each vector have magnitude greater than some constant, so that once enough affinities are known, the vectors' lengths are greater than any given value.

In some embodiments, non-negative weight W_{f} may be a configurable parameter that may adjust the rate at which the affinity similarity dominates firmographic similarity. Higher values of W_{f} may put greater weight on the firmographic similarity components, which means that a higher number of known affinities is required to reach a similar balance between firmographic and affinity-based similarity as for a lower value of W_{f}. Note that W_{f} is the length of an affinity dot product necessary before firmographics data stops dominating the function. For example, in the event that there is no user rating history, firmographic similarity dominates by default. If a user gives the maximum rating to DN1 and DN2, this is the same contribution as perfect firmographic similarity if W_{f}=1. The amount of weight given to perfect firmographic similarity is W_{f}=X, and as such it is weighted the same as if X users all gave DN1 and DN2 the maximum rating

As noted above, for a flagged DN the similarity to each other DN must be updated. Each pairwise similarity may be computed independently. Whether similarity updates are performed continuously or in batches, computation for these pairwise similarities can be distributed (e.g., on a Hadoop infrastructure or the like).

3. Item-Based Filtering Model

As is shown in operation 215, an apparatus, such as computing system 500, may include means, such as the item-based collaborative filtering module 110, the processor 803, or the like, for sorting items in descending order of inferred affinity In some embodiments, the output of the collaborative filtering sub-model may be a list of a predicted preference order for every (ST,DN) pair within one or more user cities.

The item-based filtering model may be configured to run as a batch job with for example, a frequency of 1-4 runs daily. The model may apply a simple k-nearest neighbor model to the Destination similarities and known (ST,DN) affinities to predict the preference order of all (ST,DN) affinities. Much of the preference order is likely to remain constant between consecutive batch runs; however efficiently identifying those in the preference order that will remain constant is non-trivial. Thus each batch may update all unknown affinities.

### Model Formulation

In some embodiments, configurable parameter k≧N (default value 50) may be defined to be the neighborhood size. For each (ST,DN) pair in each user city with unknown affinity, the set n_{ST}(DN) may be defined to be the k Destinations DN′ in the same city with highest similarity to DN for which aff (ST,DN′) is known. If fewer than k such affinities are known then n_{ST}(DN) may be the set of all destinations DN′ for which aff(ST,DN′) is known. The unknown (ST,DN) affinity may then be computed as:

$$aff ( ST , DN ) = \frac{{\sum }_{{DN}^{′} ∈ {n}_{ST} ( DN )} ( {sim ( DN , {DN}^{′} )}^{m} * aff ( ST , {DN}^{′} ) )}{{\sum }_{{DN}^{′} ∈ {n}_{ST} ( DN )} ( {sim ( DN , {DN}^{′} )}^{m} )} .$$

Known affinities for Destinations most similar to DN are given the greatest weight in the prediction. Configurable parameter m changes the relative weighting—higher values of m lead to a greater difference in relative weighting for the same difference in similarity.

In some embodiments, this computationally expensive batch job may be parallelized by distributing the unknown (ST,DN) affinities across machines for independent computation.

The output of the collaborative filtering sub-model may be a list indicative of a preference order for every (ST,DN) pair within each user city. However, this is likely too much data to be useful in translating into real-time recommendations. Thus the output may also be post-processed to generate a fixed-length ranked list for each ST of the destinations for which ST has the highest inferred affinities.

### Item-Based Collaborative Filtering Model Advertisements

### Model Overview

In some embodiments, the hybrid item-based collaborative filtering model may be configured to compute unknown ad click rates for a given user based on known click rates for similar ads. In a pure hybrid collaborative filtering implementation, the pairwise item (advertisement) similarity may be computed based on the similarity of known click rates between two ads across all users. The hybrid model described herein augments this similarity with an indicator, such as an indicator of whether the ads have been placed by the same advertiser. That is, ads from the same advertiser may be given a higher similarity than those from different advertisers. The relative importance of click rate similarity versus common advertiser may be adjusted through a configurable parameter.

The item-based recommendation module may require a certain density or threshold of recorded clicks for a user in order to be effective. Thus the item-based recommendation module may be, in some embodiments, only used when the user has known positive click rates for at least N advertisements, where N is a configurable model parameter.

In some embodiments, advertisements may have, or otherwise be associated with, a start and end date and may be considered active between those two dates. The item-based recommendation module may generate predicted click rates for active advertisements for each user that has not been shown the ad. In some embodiments, unknown click rates for inactive ads do not need to be predicted; however, known click rates inactive ads can be used to predict click rates for active ads. For each user, the predicted and known click rates may be used to generate a user-specific ranking of active ads.

### Model Description

FIG. 2B is a flowchart illustrating an example process that may be performed by the item-based collaborative filtering module 110 in accordance with some example embodiments (e.g., an advertisement recommendation embodiment) of the present invention. In some embodiments, the output of the item-based collaborative filtering sub-model may be a list of known or predicted click rates for every user-advertisement (ST, AID) pair where AID is active.

The item-based recommendation module may be configured to generate predicted click rates for all active advertisements for each user (ST) with recorded clicks on at least N ads (active or inactive). An advertisement may be considered active if the current date is between the ad's start and end date, inclusive. Click rates may be normalized based on ad location, such that a common ranking may be used for each location on the site.

The item-based collaborative filtering module may be configured to utilize, for each site advertisement, the following data, Advertisement ID (AID); Start/end dates: used to determine whether ad is active or inactive; Location ID (LID): site location that this particular ad. A single ad may be associated with multiple location IDs (e.g., if multiple locations of the same size exist on the site then a single ad may be eligible for multiple locations); Advertising Business ID (BID): this allows the model to link multiple ads from the same advertiser either across a campaign offering ads on multiple locations in the site or across historical campaigns (or both); History of ad impressions for each User ST of each (AID, LID) pair. An impression occurs when ad AID has been displayed in location LID while User ST is on the user site; and History of clicks for each User ST of each (AID, LID) pair.

In some embodiments, the item-based recommendation module may be composed of three sub-models: (1) click rate model; (2) advertisement similarity model; and (3) collaborative filtering model proper. The click rate model may be configured to compute known click rates for each ST. A click rate may be computed for each advertisement for which the ST has at least one impression. The click rates may be normalized across advertisement location based on overall location click rates, which may allow for a single click rate for advertisements that may appear in multiple locations and a single ranking of advertisements for the ST independent of location. The Advertisement similarity model may be configured to compute a similarity metric as a function of known click rates and whether the advertising business is the same for two different advertisements. The collaborative filtering model may be configured to use the advertisement similarities to generate predicted click rates for each ST-Advertisement pair in which the ST has not had an impression of the Advertisement.

The collaborative filtering model may be run as a batch job with the frequency of the batch update set as a parameter (e.g., 1-4 times daily in production). The outputs from the models may flow ‘downward’, such that the similarity model uses the computed click rates, and the collaborative filtering model uses the click rates and similarities. Inactive Advertisements may not be recording new impressions or clicks. Thus click rates may only need to be updated between batch runs for active Advertisements, and similarities only need to be computed for Advertisement pairs in which at least one Advertisement is active.

In some embodiments, click rates are only recomputed for user and advertisement pairs in which there has been an impression since the last batch update. Click rates may be updated more frequently between batch updates in order to reduce processing time of the batch updates in some examples. In some embodiments, similarities may also be computed more frequently between collaborative filtering batches. However, new impressions for at least one user may be likely to be recorded with high frequency for any active advertisement, and thus there may be little benefit to such an approach. It will likely be more efficient to run all three models sequentially with each batch.

In some embodiments, some advertisements may specifically target users by socio-demographic, geographic, or other variables with the explicit direction that the advertisement not be shown to users outside of the defined target group. In some embodiments, the model may be configured to read in, or otherwise receive, those constraints and compute predicted click rates only for those Advertisements for which a given ST is eligible. Additionally or alternatively, some embodiments may include associating advertisements with keywords, for example, received during a search, pacing impressions, for example, evenly, during an advertisement's lifetime, factoring known destination affinity/similarity into estimated advertisement affinity/similarity.

### Component Model Specifications

1. Click Rates

In some embodiments, the click rate for a given advertisement may be the key metric that is being estimated. Click rate may typically be computed as simply the ratio of clicks to impressions for a given AID. The Advertisement recommendation module may instead use a normalized click rate that is scaled based on the overall click rate for a given ad location. This may allow impressions and clicks on a single ad across multiple locations to be aggregated into a single click rate, and it allows comparison of click rates across ads regardless of location.

Accordingly, as is shown in operation 255, an apparatus, such as computing system 500, may include means, such as the item-based collaborative filtering module 110, the processor 803, or the like, for computing known click rates for each ST, a click rate may be computed for each advertisement for which the ST has at least one impression. Click rate may, in some embodiments, be computed as the ratio of clicks to impressions for a given AID.

In some embodiments, a portion of click rates may not change between consecutive batch runs. Thus known click rates can be stored between batches and updated only as required. Click rates for inactive ads (Advertisements for which the current date falls outside of the start and end dates) may not need to be updated. For active ads, a ST-AID pair may be flagged for update if either of the following events occurs: (1) An impression of AID is recorded for ST; (2) ST clicks on AID. Click rates may be updated before each collaborative filtering batch run. In some embodiments, the module may be configured to update click rates at a higher frequency between batch runs.

### Model Formulation

In some embodiments, configurable parameter nₘᵢₙ may be defined as the minimum number of impressions that must be recorded for a given (ST,AID) pair in order for the click rate to be computed (rather than inferred). For a user, advertisement, location triple (ST,AID,LID), the following impression and click variables may be defined:

I_{ST,AID,LID}=count of impressions for ST of AID at LID

C_{ST,AID,LID}=count of clicks by ST of AID at LID

The overall click rate for a Location LID may be then computed as:

$${rate}_{loc} ( LID ) = \frac{{\sum }_{ST , AID} {C}_{ST , AID , LID}}{{\sum }_{ST , AID} {I}_{ST , AID , LID}} .$$

The absolute and normalized click rates for a given ad AID by user ST at location LID are, respectively:

$$rate ( ST , AID , LID ) = \frac{{C}_{ST , AID , LID}}{{I}_{ST , AID , LID}}$$

$$\overline{rate} ( ST , AID , LID ) = \frac{rate ( ST , AID , LID )}{{rate}_{loc} ( LID )} .$$

If there have been no impressions for a given (ST,AID,LID) triple then both values may be set to 0. The normalized click rate may scale the absolute click rate by the overall location click rate to enable comparisons to be made across different locations.

If a ST has recorded zero clicks on ad AID and has had fewer than nₘᵢₙ impressions of AID then the normalized click rate for that (ST,AID) is set to null to indicate that it needs to be predicted by the collaborative filtering model. Otherwise, the normalized rate may be set equal to a weighted sum of the adjusted click rates across locations with the number of impressions as the weighting factor:

$$\overline{rate} ( ST , AID ) = \frac{{\sum }_{LID} ( {I}_{ST , AID , LID} * \overline{rate} ( ST , AID , LID ) )}{{\sum }_{LID} {I}_{ST , AID , LID}} .$$

2. Advertisement Similarity Model

As is shown in operation 260, an apparatus, such as computing system 500, may include means, such as the item-based collaborative filtering module 110, the processor 803, or the like, for computing a similarity metric between one or more advertisement pairs as a function of known click rates and a component that increases similarity when the advertising business matches between two advertisements. In other words, the component is a function of whether the advertising business is the same for two different advertisements. In some embodiments, a similarity metric may be required for all pairs of advertisements in which at least one advertisement is active.

The Advertisement similarity model may be a modified cosine similarity metric across the normalized (ST,AID) click rates that include a component that increases similarity when the advertising business matches between two advertisements. The weight placed on this parameter is configurable in some examples.

Similarities may be required for all pairs of advertisements in which at least one advertisement is active (ad start date≦current date≦ad end date). Similarities may be updated for each (AID1,AID2) pair in which an impression or click has been recorded for either ad. The rate of impressions is likely to be high enough that all active advertisements receive impressions between batch runs. Therefore, it is likely that similarities may need to be recomputed for every ad pair with an active ad prior to every batch run. However, in some embodiments, the number of active advertisements is likely to be low enough (i.e., below a predefined threshold) that this does not present a significant computing challenge.

### Model Formulation

In some embodiments, configurable parameter W_{BID} may be defined as the weight in interval [0,1] assigned to a business ID or destination in computing similarities. This may imply a (1−W_{BID}) weight on click rate similarity.

For each advertisement AID, rating vector R_{AID} may be defined as the vector of adjusted click rates r̅a̅t̅e̅(ST,AID) for each ST with null values set to zero. In some embodiments, vector dot-product may also be defined.

$${R}_{{AID}_{1}} \cdot {R}_{{AID}_{2}} = {\sum }_{ST} ( \overline{rate} ( ST , {AID}_{1} ) * \overline{rate} ( ST , {AID}_{2} ) )$$

Vector magnitude may also be defined:

$$‖ {R}_{AID} ‖ = \sqrt{{\sum }_{ST} ( {\overline{rate} ( ST , AID )}^{2} )} .$$

Indicator function x_{BID}(AID₁,AID₂) may be equal to 1 if AID1 and AID2 have the same advertising business and zero otherwise. Then the similarity of AID1 and AID2 may be defined as:

$$sim ( {AID}_{1} , {AID}_{2} ) = {W}_{BID} {x}_{BID} ( {AID}_{1} , {AID}_{2} ) + ( 1 - {W}_{BID} ) \frac{{{R}_{AID}}_{1} - {R}_{{AID}_{2}}}{‖ {R}_{{AID}_{1}} ‖ ‖ {R}_{{AID}_{2}} ‖} .$$

In some embodiments, similarities may need only be recomputed for (AID1, AID2) pairs in which at least one of the advertisements has new normalized click rates for at least one user since the last batch update. It may not be necessary to compute similarities for (AID1, AID2) pairs for which both ads are no longer active (i.e., current date is outside of the ad start date and end date, inclusive).

Similarities may be computed independently for each pair. Thus the computation may be distributed.

Similarities may be symmetric, e.g., sim(AID₁,AID₂)=sim(AID₂,AID₁). There may therefore ne no need to compute the similarities for both (AID1, AID2) and (AID2,AID1) as long as both similarities are updated when one is computed.

3. Item-Based Filtering Model

As is shown in operation 265, an apparatus, such as computing system 500, may include means, such as the item-based collaborative filtering module 110, the processor 803, or the like, for sorting items in descending order of inferred affinity. That is, an inferred click rate may be determined for each ST-Advertisement pair in which the ST has not had an impression of the advertisement using the advertisement similarities. The output may be a list of all ST-Advertisement pairs in descending order of affinity, some empirical, some inferred.

The item-based filtering model may be configured to run as a batch job, with a frequency of, for example, 1-4 runs daily. The model may apply a simple k-nearest neighbor model (with configurable parameter k) to the advertisement similarities and known (ST, AID) click rates to predict all unknown (ST, AID) click rates. Because similarities are likely to change between each batch run, all unknown click rates for active advertisements may need to be recomputed during each batch.

### Model Formulation

In some embodiments, for each (ST, AID) pair with an unknown click rate and where AID is active, the set n_{ST}(AID) may be defined to be the k Advertisements AID′ (active or inactive) with highest similarity to AID for which r̅a̅t̅e̅(ST,AID′) is known. Then the unknown (ST,AID) click rate may be computed as:

$$\overline{rate} ( ST , AID ) = \frac{{\sum }_{{AID}^{′} ∈ {n}_{ST} ( AID )} ( {sim ( AID , {AID}^{′} )}^{m} * aff ( ST , {AID}^{′} ) )}{{\sum }_{{AID}^{′} ∈ {n}_{ST} ( AID )} ( {sim ( AID , {AID}^{′} )}^{m}}$$

Known click rates for advertisements most similar to AID may be given the greatest weight in the prediction. Configurable parameter m changes the relative weighting—higher values of m lead to a greater difference in relative weighting for the same difference in similarity.

Click rates may need only be predicted for active Advertisements. The batch job may be parallelized by distributing the unknown (ST, AID) affinities across machines for independent computation. The output of the collaborative filtering sub-model may be a list of known or predicted click rates for every (ST, AID) pair where AID is active.

### Exemplary Process for User-Based Collaborative Filtering Module

### User-Based Collaborative Filtering Model for Destinations

### Model Overview

In some embodiments, as described above, the item-based collaborative filtering model may require a sufficient amount of affinity data for a given user in order to predict their unknown preferences. However, for a newly registered user or a user with limited recorded activity, the item-based collaborative filtering model may not perform well, such as it may perform below a defined performance threshold. As such, the user-based collaborative filtering model may be utilized.

When a user has fewer than N known affinities, the user's unknown affinities may be predicted using a hybrid user-based collaborative filtering model. User-based collaborative filtering may transpose item-based filtering. That is, instead of predicting affinity based on a user's known affinities for similar destinations, user-based filtering predicts affinity based on known affinities of similar users for the same destination. Hybrid user-based collaborative filtering may use both socio-demographic variables and known affinities to compute similarity.

The user-based recommendation module may be configured to generate the same outputs as the item-based model: predicted preferences for user-destination pairs in each user city with unknown preference. In some embodiments, the predictions may be generated only for those pairs where the user does not have enough known affinities to qualify for the item-based recommender. For each user, the predicted and known preferences may be used to generate a user-specific preference ranking over all destinations.

### Model Description

FIG. 3A is a flowchart illustrating an example process that may be performed by the user-based collaborative filtering module 112 in accordance with some example embodiments (e.g., a destination recommendation embodiment) of the present invention. In some embodiments, the output of the collaborative filtering sub-model may be a list of a known or predicted (ST, DN) affinity for each of one or more (ST, DN) pairs. In some embodiments, the output may a fixed-length ranked list for each ST of the destinations for which ST has the highest known or predicted affinities.

The user-based recommendation module may be configured to generate affinities for every pair of user and destination in each user city where the number of known affinities for the user is less than N. The model may be a hybrid user-based collaborative filtering model. This model may be composed of 3 sub-models: (1) an affinity model; (2) user similarity model; and (3) a collaborative filtering model proper.

The affinity model may be configured to compute ST-DN affinities as a function of ST site behaviors related to the DN: follows, favorites, activations at Destinations, acceptance of deals, etc. The user similarity model may be configured to compute a similarity metric as a function of socio-demographic and ST preference variables and known ST-DN affinities. The collaborative filtering model proper may be configured to use the user similarities to generate predictions for unknown ST-DN affinities.

In some embodiments, the model flow may be the same as for the item-based recommender. The key difference between the models is that the user-based recommender uses user similarity instead of destination similarity. As in the case of the item-based recommendation module, the user-based recommendation module may be updated in batches, for example, at approximately 1-4 times per day. The affinity and similarity components may be updated more frequently between batches to reduce the peak loads during batch processing.

### Component Model Specifications

1. Affinity Model

The affinity model for the user-based recommendation module may be configured the same as or similar to the affinity model for the item-based recommendation module. The two affinity models, in some embodiments, may in fact be run as a single model, and the computed affinities may not need to be segregated until they are input into the appropriate similarity and filtering sub-models. Accordingly, as is shown in operation 305, an apparatus, such as computing system 500, may include means, such as the user-based collaborative filtering module 112, the processor 803, or the like, for computing ST-DN affinities as a function of ST site behaviors related to the DN.

2. User Similarity Model

The user similarity model may be configured to generate pairwise similarities between users. As is shown in operation 310, an apparatus, such as computing system 500, may include means, such as the user-based collaborative filtering module 112, the processor 803, or the like, for computing a similarity metric between two users as a function of socio-demographic and ST preference variables and known ST-DN affinities.

In some embodiments, the similarity metric may then be computed as a modified cosine similarity between the extended socio-demographic and affinity vectors of the users. The model may be constructed in such a way that as the number of known affinities may increase for a user, the relative weight of affinity similarity naturally increases compared to socio-demographic similarity in the overall similarity computation.

The user-based filtering model may require that similarities be computed for all (ST1, ST2) pairs in which at least one of ST1 or ST2 does not meet the threshold requirement for the item-based recommendation module. The processing flow for the user similarity model is similar to that of the destination similarity model described above. As is the case for the destination model, many ST similarities are likely to remain unchanged between consecutive batch runs of the filtering model. Therefore, the similarities may be stored between batch runs and be computed/recomputed only as required. A ST may be flagged as needing to have its similarities updated if any of the following occur: (1) The ST is new to the system (i.e., does not have any similarities); (2) The relevant ST profile information has been updated either by the user or the system; (3) One or more (ST, DN) affinities have been updated for this ST.

When a ST is flagged, the similarities between that ST and all other STs in the same user city may be recomputed. In some embodiments, similarities may be symmetric, meaning that sim(ST₁,ST₂)=sim(ST₂,ST₁). Thus it may be important that recomputed similarities be updated for both pair orderings if they are stored separately, although the computation may only be performed a single time.

As in the destination similarity model, flagged STs may be updated continuously by triggering the similarity model immediately when a ST is flagged, or the flagged STs may be updated in batches. The update frequency may be no more frequent than the affinity update frequency and no less frequent than the collaborative filtering batch frequency.

The logic below describes the algorithm for computing similarity for a single pair of STs.

### Model Formulation

The similarity between two Users ST1 and ST2 may be computed as a cosine-like similarity function over a set of pure cosine similarity sub-functions. The similarity may be a real number on an interval, for example [−1,1], with a higher value indicating greater similarity.

The model may be configured to first compute a socio-demographic similarity between ST1 and ST2. The input socio-demographic dimensions are: (1) Demographics; (2) Age (normalized onto [−1,1] interval; unknown age set to median); (3) Gender (1=M, −1=F, 0=unknown); (4) Interests; Drink of choice; Sports interests (e.g., up to 5); Favorite music (e.g., up to 5); Favorite food (e.g., up to 5); Favorite travel destination (e.g., up to 5); Hobbies/interests (e.g., up to 5); Personal Style (e.g., up to 5); Favorite Destinations. Additionally or alternatively, the model may be configured to utilize social media data. That is, in a social media environment, social media data may provide another important source of user-similarity information. Specifically, any reciprocal measure of user-user interaction may be considered to suggest, for example, a certain mutual influence between the actions of ST1 and ST2 and such information may be encoded in the user-similarity. In some embodiments, a new sub-function may be utilized in the form of a weighted sum over many cosine similarity sub-functions. Each of these sub-functions may be configured to measure similarity in terms of a different user-user relationship (i.e. a different kind of possible social media interaction (e.g., are ST1 and ST2 “friends” on social media, what is the set similarity between ST1 and ST2 “friends” on social media, do ST1 and ST2 “chat” with each other more often than a certain threshold rate of chats per time, or the like).

The interest dimensions may be concatenated into a single list for each ST. The socio-demographic similarity between ST1 and ST2 may then be computed as:

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

where a_{ST}_{₁} and a_{ST}_{₂} are the age (normalized) and gender, respectively, of User ST. Wₐ and W_{g} may be configurable weights controlling the relative contribution of the age and gender dimensions, respectively, to the overall user similarity.

Similar to the destination model, the final user similarity measure may be a function of the socio-demographic similarities defined above and the known affinities of each user. V_{ST} may be defined to be the vector of (ST,DN) affinities across all destinations DN in the city. If the affinity is null (i.e., unknown) then the corresponding element of the vector may be set to zero. Then the user similarity between ST1 and ST2 may be defined as:

$$sim ( {ST}_{1} , {ST}_{2} ) = \frac{{W}_{sd} sim ( {ST}_{1} , {ST}_{2} ) + {V}_{{ST}_{1}} \cdot {V}_{{ST}_{2}}}{\sqrt{{W}_{sd} + {\sum }_{DN} ( {aff ( {ST}_{1} , DN )}^{2} )} * \sqrt{{W}_{sd} + {\sum }_{DN} ( {aff ( {ST}_{2} , DN )}^{2} )}} .$$

As was the case for the destination similarity model, the user similarity model may adjust weight toward the affinity component of the similarity as more affinities become known for either ST1 or ST2. Non-negative weight W_{sd} may be a configurable parameter that may adjust the rate at which the affinity similarity gains influence over the socio-demographic similarity. Higher values of W_{sd} put greater weight on the socio-demographic similarity components, which may mean that a higher number of known affinities is required to reach a similar balance between socio-demographic and affinity-based similarity as for a lower value of W_{sd}.

As is the case for the destination similarity model, for a flagged ST the similarity to each other ST may be updated. Each pairwise similarity may be computed independently. Whether similarity updates are performed continuously or in batches, computation for these pairwise similarities can be distributed (e.g., on a Hadoop infrastructure).

3. User-Based Filtering Model

As is shown in operation 315, an apparatus, such as computing system 500, may include means, such as the user-based collaborative filtering module 112, the processor 803, or the like, for sorting items in descending order of inferred affinity. In some embodiments, the apparatus is configured to output a list of a predicted preference order of all unknown (ST, DN) affinities for users without enough known affinities to meet the item-base model threshold.

In some embodiments, the user-based filtering model may be configured to run as a batch job. The frequency may be the same as for the item-based model. The user-based model may be a transposition of the item-based model. The user-based model may apply a simple k-nearest neighbor model to the user similarities and known (ST, DN) affinities to predict all unknown (ST, DN) affinities for users without enough known affinities to meet the item-base model threshold. Many predicted affinities are likely to remain constant between consecutive batch runs; however, efficiently identifying the predicted affinities that will remain constant is non-trivial. Thus each batch may update all unknown affinities in some examples.

Model Formulation

In some embodiments, configurable parameter k (default value 50) may be defined to be the neighborhood size. For each (ST, DN) pair in each user city with unknown affinity, the set n_{DN}(ST) may be defined to be the k Users ST′ in the same city with highest similarity to ST for which aff (ST′,DN) is known. If fewer than k such affinities are known then n_{DN}(ST) may be the set of all Users ST′ for which aff(ST′,DN) is known. In some embodiments, a configurable variable kₘᵢₙ≦k (default value 20) may also be defined. If no known exist for DN then, in some embodiments, aff(ST,DN)=0. If |n_{DN}(ST)|≧kₘᵢₙ then the unknown (ST,DN) affinity may be computed as:

$$aff ( ST , DN ) = \frac{{\sum }_{{ST}^{′} ∈ {n}_{DN} ( ST )} ( {sim ( ST , {ST}^{′} )}^{m} * aff ( {ST}^{′} , DN ) )}{{\sum }_{{ST}^{′} ∈ {n}_{DN} ( ST )} ( {sim ( ST , {ST}^{′} )}^{m} )} .$$

If instead 0<|n_{DN}(ST)|<kₘᵢₙ then the unknown affinity may be computed as:

$$aff ( ST , DN ) = \frac{{\sum }_{{ST}^{′} ∈ {n}_{DN} ( ST )} ( {sim ( ST , {ST}^{′} )}^{m} * aff ( {ST}^{′} , DN ) )}{{\sum }_{{ST}^{′} ∈ {n}_{DN} ( ST )} ( {sim ( ST , {ST}^{′} )}^{m} )} * \frac{{log}_{b} ( 1 + \vert {n}_{DN} ( ST ) \vert )}{{log}_{b} ( 1 + {k}_{min} )} .$$

In some embodiments, the second term may scale the inferred rating based on the number of known affinities—a small number of known affinities means relatively less confidence in the validity of the mean affinity, and thus the mean affinity is scaled toward zero. In some embodiments, b is a configurable parameter. As the number of known affinities approach kₘᵢₙ, this ratio approaches 1, and the impact of the scaling factor may decrease.

Known affinities for users most similar to ST may be given the greatest weight in the prediction. In some embodiments, configurable parameter m may change the relative weighting—higher values of m lead to a greater difference in relative weighting for the same difference in similarity.

The common parameters for user- and item-based models (k and m) may in fact have different values and may be initialized in the implementation as distinct parameters. This computationally expensive batch job may be parallelized by distributing the unknown (ST, DN) affinities across machines for independent computation.

The output of the collaborative filtering sub-model may be a list of known or predicted (ST, DN) affinity for every (ST, DN) pair within each user city. However, this may be, in some embodiments, too much data to be useful in translating into real-time recommendations. Thus the output may be post-processed to generate a fixed-length ranked list for each ST of the Destinations for which ST has the highest known or predicted affinities.

### User-Based Collaborative Filtering Model Advertisements

### Model Overview

In some embodiments, the item-based collaborative filtering model may require a sufficient number of known (ST, AID) click rates for a given user in order to predict click rates for that user on other advertisements. For a newly registered user or a user with limited recorded activity, the model may not perform above a model performance level. This is known, and has been described herein, as the user cold start problem.

When a user has recorded clicks on fewer than N advertisements, the user's unknown click rates may be predicted using a hybrid user-based collaborative filtering model. User-based collaborative filtering transposes item-based filtering. That is, instead of predicting click rates based on a user's known click rates on similar advertisements, user-based filtering predicts click rates based on observed click rates of similar users for the same advertisement. Hybrid user-based collaborative filtering may use both socio-demographic variables and known click rates to compute similarity.

The user-based collaborative filtering model is complementary to the item-based model. Both generate predicted click rates for (ST, AID) pairs with no known impressions, but they do so for two different sets of users.

Some advertisements may specifically target STs by socio-demographic, geographic, or other variables with the explicit direction that the advertisement not be shown to STs outside of the defined target group. In some embodiments, those constraints may be received and predicted click rates may be computed only for those advertisements for which a given ST is eligible.

### Model Description

FIG. 3B is flowchart illustrating an example process that may be performed by the user-based collaborative filtering module 112 in accordance with some example embodiments (e.g., an advertisement recommendation embodiment) of the present invention. The output, in some embodiments, is predicted click rates for each (ST, AID) pair in which the ST has not had an impression of the advertisement.

The user-based collaborative filtering module may be configured to predict click rates for every (ST, AID) pair in which ad AID is active, ST has not yet had an impression of AID, and the total number of advertisements that ST has clicked on is less than N. The user-based collaborative filtering module may be configured as a hybrid user-based collaborative filtering model, and may be comprised of sub-models: (1) a click rate model; (2) a user similarity model; and (3) a collaborative filtering model proper.

The click rate model may be configured to compute known click rates for each ST. This model may be the same as the click rate model for the item-based recommender. The user similarity model may be configured to compute a similarity metric as a function of socio-demographic and ST preference variables and known (ST, AID) click rates. The collaborative filtering model proper may be configured to use the user similarities to generate predicted click rates for each (ST, AID) pair in which the ST has not had an impression of the advertisement.

In some embodiments, the required input data for the user-based collaborative filtering module may include some portion of or, in some embodiments, all inputs for the item-based model except the advertising business. In addition, ST socio-demographic and preference variables may be required. These variables are specified in the user similarity model description.

The model flow may be the same as for the item-based recommendation module. The key difference between the two models is that the user-based collaborative filtering module uses user similarity instead of advertiser similarity. As in the case of the item-based collaborative filtering module, the user-based model may be updated in batches, at a frequency of, for example, approximately 1-4 times per day. The click rate and user similarity component models may be updated more frequently between batches to reduce the peak loads during batch processing.

A difference between the item-based and user-based modules is that, whereas the advertisements similarity model in the item-based collaborative filtering module may compute similarities for a relative small number of active advertisements, the number of user pairs that must be evaluated in the user-based user similarity model may be significant. Possible example implementation strategies that would mitigate this challenge are discussed in the user similarity model description.

### Component Model Specifications

1. Click Rate Model

The click rate model for the user-based recommender may be the same as or similar to the click rate model for the item-based recommendation module. In some embodiments, the two models may in fact be run as a single model, and the computed click rates may not need to be segregated until they are input into the appropriate similarity and filtering sub-models. Accordingly, as is shown in operation 355, an apparatus, such as computing system 500, may include means, such as the user-based collaborative filtering module 112, the processor 803, or the like, for computing known click rates for each ST, a click rate may be computed for each advertisement for which the ST has at least one impression.

2. User Similarity Model

The User similarity model may be configured to generate pairwise similarities between users. As is shown in operation 360, an apparatus, such as computing system 500, may include means, such as the user-based collaborative filtering module 112, the processor 803, or the like, for computing a similarity metric as a function of socio-demographic and ST preference variables and known (ST,AID) click rates. For example, in some embodiments, the apparatus may be configured to apply a simple k-nearest neighbor model to the user similarities and known (ST,AID) click rates to predict all unknown (ST,AID) click rates for users that do not meet the click threshold for the item-based recommendation model. In some embodiments, the apparatus may be configured for, as the number of known click rates increases for a user, increasing the relative weight of click rate similarity compared to socio-demographic similarity in the overall similarity computation.

In some embodiments, similarity may be computed as a modified cosine similarity between the extended socio-demographic and click rate vectors of the users. The model may be constructed in such a way that as the number of known click rates increases for a user, the relative weight of click rate similarity naturally increases compared to socio-demographic similarity in the overall similarity computation.

The model is very similar to the user similarity model for the destination recommendation module. The primary difference is in the use of click rates in place of ST-Destination affinities.

In some embodiments, the user-based filtering model may require that similarities be computed for all (ST1,ST2) pairs in which at least one of ST1 or ST2 does not meet the threshold requirement for the item-based recommender. Many ST similarities are likely to remain unchanged between consecutive batch runs of the filtering model. Therefore, the similarities may be stored between batch runs and be computed/recomputed only as required. A ST may be flagged as needing to have its similarities updated if any of the following occur: (1) The ST is new to the system (i.e., does not have any similarities); (2) The relevant ST profile information has been updated either by the user or the system; or (3) The ST has recorded at least one new impression or click for any advertisement.

In some embodiments, when a ST is flagged, the similarities between that ST and all other STs may be recomputed (see implementation note below for discussion). Similarities may be symmetric, meaning that sim(ST₁,ST₂)=sim(ST₂,ST₁) so that recomputed similarities may be updated for both pair orderings if they are stored separately.

In some embodiments, similarities for flagged STs are updated in more frequent batches than the frequency of the user-based collaborative filtering sub-model in order to, for example, gain efficiency The update frequency may be no more frequent than the click rate update frequency and no less frequent than the collaborative filtering batch frequency in some example, however other frequencies may be envisioned in other examples.

The logic below describes an example algorithm for computing similarity for a single pair of STs.

### Model Formulation

The similarity between two users ST1 and ST2 may be computed as a cosine-like similarity function over a set of pure cosine similarity sub-functions. The similarity may be a real number on an interval, for example, the interval [−1,1], with a higher value indicating greater similarity.

In some embodiments, the model first may be configured to compute a socio-demographic similarity between ST1 and ST2. The input socio-demographic dimensions are: Demographics; Age (normalized onto [−1,1] interval; unknown age set to median); Gender (1=M, −1=F, 0=unknown); Interests; Drink of choice; Sports interests (up to 5); Favorite music (up to 5); Favorite food (up to 5); Favorite travel destination (up to 5); Hobbies/interests (up to 5); Personal Style (up to 5); and Favorite Destinations;

The interest dimensions may concatenate into a single list for each ST. The socio-demographic similarity between ST1 and ST2 may then computed as:

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

where a_{ST}_{₁} and a_{ST}_{₂} are the age (normalized) and gender, respectively, of ST. Wₐ and W_{g} may be configurable weights controlling the relative contribution of the age and gender dimensions, respectively, to the overall user similarity.

The final user similarity measure may be a function of the socio-demographic similarities defined above and the known click rates of each user. VST may be defined to be the vector of (ST,AID) click rates across all Advertisements AID. If the click rate for a given (ST,AID) pair is null (i.e., unknown) then the corresponding element of the vector may be set to zero. Then the User similarity between ST1 and ST2 may be defined as:

$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\begin{matrix}\sqrt{{W}_{sd} + {\sum }_{AID} ( {\overline{rate} ( {ST}_{1} , AID )}^{2} )} * \\ \sqrt{{W}_{sd} + {\sum }_{AID} ( {\overline{rate} ( {ST}_{2} , AID )}^{2} )}\end{matrix}} .$$

The User similarity model may naturally adjust weight toward the click rate component of the similarity as more click rates become known for either ST1 or ST2. Non-negative weight W_{sd} may a configurable parameter that may adjust the rate at which the click rate similarity gains influence over the socio-demographic similarity. Higher values of W_{sd} may put greater weight on the socio-demographic similarity components, which means that a higher number of known click rates may be required to reach a similar balance between socio-demographic and click-based similarity as for a lower value of W_{sd}.

In some embodiments, for a flagged ST, the similarity to each other ST may be updated. Each pairwise similarity may be computed independently. Whether similarity updates are performed continuously or in batches, computation for these pairwise similarities can be distributed (e.g., on a Hadoop infrastructure).

In some embodiments, the similarities may be updated between collaborative filtering batch runs in order to reduce peak processing loads. In some embodiments, some (ST1,ST2) similarities may be overwritten in that case if one of the STs is again flagged before the next full-model batch update, and thus the tradeoff may be analyzed to determine whether more frequent updates may be performed to, for example, improve computational performance.

In some embodiments, because a plurality of advertising campaigns are likely to be national or regional, ST similarities may ideally be computed for all (ST1,ST2) pairs, regardless of user city, in which at least one ST does not meet the threshold for the item-based recommendation module. The large number of users across the system may make this impractical. One potential solution to this issue is to partition the user-based recommendation module by social city. The accuracy of the model may decrease marginally relative to the reduction in computational requirements. Alternative partitioning rules may be set that cluster dynamically based on number of active users, for example, newly launched cities may be combined with one or more geographically and/or demographically similar cities until the number of users in the new city reaches a specified threshold.

3. User-Based Filtering Model

As is shown in operation 365, an apparatus, such as computing system 500, may include means, such as the user-based collaborative filtering module 112, the processor 803, or the like, for sorting items in descending order of inferred affinity. In some embodiments, the output of the collaborative filtering sub-model may be a list of a predicted preference order for each (ST,AID) pair in which the ST has not had an impression of the advertisement using the user similarities.

In some embodiments, the user-based filtering model may be configured to run as a batch job. The frequency may be the same as for the item-based model. The user-based model may be a transposition of the item-based model. The user-based model may apply a simple k-nearest neighbor model to the user similarities and known (ST,AID) click rates to predict all unknown (ST,AID) click rates for users that do not meet the click threshold for the item-based recommender. Many predicted click rates are likely to remain constant between consecutive batch runs; however efficiently identifying the predicted click rates that may remain constant is non-trivial. Thus each batch may update all unknown click rates.

### Model Formulation

In some embodiments, configurable parameter k (default value 50) may be defined as the neighborhood size. For each (ST,AID) pair with unknown click rate, the set n_{AID}(ST) may be defined to be the k Users ST′ in with highest similarity to ST for which r̅a̅t̅e̅(ST′,AID) is known. If the number of known click rates for AID is less than k then n_{AID}(ST) will be the set of all users ST′ for which r̅a̅t̅e̅(ST′,AID) is known. If no known click rates exist for AID then the predicted (ST,AID) click rate may be set to zero.

Otherwise, the click rate may be predicted as:

$$\overline{rate} ( ST , AID ) = \frac{{\sum }_{{ST}^{′} ∈ {n}_{AID} ( ST )} ( {sim ( ST , {ST}^{′} )}^{m} * \overline{rate} ( {ST}^{′} , AID ) )}{{\sum }_{{ST}^{′} ∈ {n}_{AID} ( ST )} ( {sim ( ST , {ST}^{′} )}^{m} )} .$$

Known click rates for users most similar to ST may be given the greatest weight in the prediction. In some embodiments, configurable parameter m may change the relative weighting such that, for example, higher values of m lead to a greater difference in relative weighting for the same difference in similarity.

The common parameters for user- and item-based models (k and m) may have different values and may be initialized in the implementation as distinct parameters. Additionally, these parameters are distinct from the similar parameters in the destination recommendation module.

Batch job may be parallelized by distributing the unknown (ST,AID) click rates across machines for independent computation.

### Exemplary Process for Global Average Module

### Destinations

### Model Overview

In some embodiments, when a new user registers for the system, predicted affinities may be generated for that user in the next run of the collaborative filtering algorithms. The model, however, may still need to be able to recommend destinations for these users until user-specific recommendations become available. In this case, the model may use global average affinities across all users, adjusted for number of known affinities, as a stand in until a next collaborative filtering model run.

FIG. 4A is a flowchart illustrating an example process that may be performed by the global average module 114 in accordance with some example embodiments (e.g., a destination recommendation embodiment) of the present invention.

As is shown in operation 405, an apparatus, such as computing system 500, may include means, such as the global average module 114, the processor 803, or the like, for computing ST-DN affinities as a function of ST site behaviors related to the DN. As is shown in operation 410, an apparatus, such as computing system 500, may include means, such as the global average module 114, the processor 803, or the like, for, identifying, for each DN, the set of all users in the current city with known (ST,DN) affinity. As is shown in operation 415, an apparatus, such as computing system 500, may include means, such as the global average module 114, the processor 803, or the like, for sorting items in descending order of inferred affinity. In some embodiments, the output of the sub-model may be a list of a user independent predicted preference order for DN affinities based on the mean of all known affinities for each DN. In some embodiments, the predictions may be scaled based on the number of known affinities.

In some embodiments, global affinities may be computed in a manner similar to the user-based filtering model described above. For Destination DN, N_{DN} may be defined as the set of all users ST in the current city with known (ST, DN) affinity. If no such ST exist (i.e., there are no known affinities for DN) then the global affinity prediction aff(DN) may be set to zero. If |N_{DN}|<kₘᵢₙ, where kₘᵢₙ is the same parameter as defined above, then:

$$aff ( D N ) = \frac{{\sum }_{ST ∈ {N}_{DN}} aff ( ST , DN )}{\vert {N}_{DN} \vert} * \frac{{log}_{b} ( 1 + \vert {N}_{DN} ( ST ) \vert )}{{log}_{b} ( 1 + {k}_{min} )} .$$

The first term may be the mean of all known affinities for DN. Note that because the known affinities include a normalized rating component, the known affinities may be either positive or negative. The second term scales the mean rating based on the number of known affinities, a small number of known affinities means relatively less confidence in the validity of the mean affinity, and thus the mean affinity is scaled toward zero.

If instead |N_{DN}|≧kₘᵢₙ then set:

$$aff ( D N ) = \frac{{\sum }_{ST ∈ {N}_{DN}} aff ( ST , DN )}{\vert {N}_{DN} \vert} .$$

results in an arithmetic mean over all known affinities for DN.

Note that the global average (GA) model may be configured to assign each destination a constant rating, based on an assumption that all users have the same preferences. While this assumption is dubious, it's the most that can be said until we know more about the destinations or the users. To determine “how much” observed affinities are enough to switch away from using GA, statistics may be utilized. A goal of the system may be to always make recommendations for a user (or destination) using the model that is expected to have the least error. GA performs the best under the most uncertainty, so the GA prediction is our null hypothesis, and the CF models are alternate hypotheses. The error comes from comparing the three model's predictions for each observed affinity. This gives three errors, and the model with the smallest expected error is the model chosen/selected at the time the recommendations are built/determined for a user. If the error for a DN is lowest with GA, then GA should be used for that DN—otherwise, where item-based CF has a lower error, item-based CF should be used. If the error for an ST is lowest with GA, then the GA should be used for that ST—otherwise, where user-based CF has a lower error, user-based CF may be used. The errors may not be known until after-the-fact, and as such, the system may not be configured in terms of error directly. Instead, statistical analysis of past affinities may be computed to determine other values which indicate at or near what point the error of GA exceeds the error of CF—these values are mentioned above (N, k, m, etc.) and the system may then perform best when these values are determined using statistical methods.

Note that this affinity computation may be independent of ST. Thus the predicted affinity may need only be computed once for each DN and used for any new user that was not included in the previous collaborative filtering model runs.

This model may be much less computationally intensive than the collaborative filtering models described above and may therefore be run with higher frequency update cycles than for the collaborative filtering models in some examples. However, given that global affinities are likely to change slowly over time, the system may be configured to run once per day, although other frequencies may be envisioned in some examples.

In the initial implementation, the system cold start model may also be applied when a new city is introduced. In some embodiments, however, new cities may be able to leverage information from existing user cities to improve recommendations immediately, e.g., via knowledge-based models trained on existing cities.

### Advertisements

### Model Overview

Similar to above, in some embodiments, when a new user registers for the system, no predicted click rates may be generated for that user until the next run of the collaborative filtering algorithms. The model, however, may still need to be able to recommend advertisements for these users until user-specific recommendations become available. In this case, the model may use global normalized click rates across all users.

FIG. 4B is a flowchart illustrating an example process that may be performed by the global average module 114 in accordance with some example embodiments (e.g., an advertisement recommendation embodiment) of the present invention.

Accordingly, as is shown in operation 455, an apparatus, such as computing system 500, may include means, such as the global average module 114, the processor 803, or the like, for computing known click rates for each ST, a click rate may be computed for each advertisement for which the ST has at least one impression. As is shown in operation 460, an apparatus, such as computing system 500, may include means, such as the global average module 114, the processor 803, or the like, for, for each advertisement, identifying the set of all users with known click rate. As is shown in operation 465, an apparatus, such as computing system 500, may include means, such as the global average module 114, the processor 803, or the like, for for sorting items in descending order of inferred affinity. In some embodiments, the output of the sub-model may be a list of a user independent predicted preference order for each advertisement.

In some embodiments, the global click rates may be computed similarly to the user-specific click rates described above. In some embodiments, the total clicks and impressions for ad AID at location LID may be defined as, respectively:

$${C}_{AID , LID} = {\sum }_{ST} {C}_{ST , AID , LID}$$

$${I}_{AID , LID} = {\sum }_{ST} {I}_{ST , AID , LID}$$

The location click rate is defined as above:

$${rate}_{loc} ( LID ) = \frac{{\sum }_{ST , AID} {C}_{ST , AID , LID}}{{\sum }_{ST , AID} {I}_{ST , AID , LID}} = \frac{{\sum }_{AID} {C}_{AID , LID}}{{\sum }_{AID} {I}_{AID , LID}} .$$

The absolute and normalized click rates for a given ad AID at location LID may be computed across all users instead of individually for each user. They are, respectively:

$$rate ( AID , LID ) = \frac{{C}_{AID , LID}}{{I}_{AID , LID}}$$

$$\overline{rate} ( AID , LID ) = \frac{rate ( AID , LID )}{{rate}_{loc} ( LID )} .$$

The overall normalized click rate for AID is:

$$\overline{rate} ( AID ) = \frac{{\sum }_{LID} ( {I}_{AID , LID} * \overline{rate} ( AID , LID ) )}{{\sum }_{ST , AID} {I}_{ST , AID , LID}} .$$

In some embodiments, the predicted click rates r̅a̅t̅e̅(AID) are independent of ST. Thus the predicted click rate may need only be computed once for each AID during the overall recommender batch run and used to respond to system queries for which the user is unknown to the recommendation module.

This model is may be less computationally intensive than the collaborative filtering models described above and may therefore be run with higher frequency update cycles than for the collaborative filtering models. In some embodiments, given that global click rates are likely to change slowly over time, the system may be configured to run the updates less frequently, for example, once per day.

### Generating Keyword Search Results

In some embodiments, the recommendation module (e.g., the destination recommendation model and the advertisement recommendation module) may be configured to generate recommendations in response to a user's keyword search. In some embodiments, two lists of results may be generated by sorting on different metrics: (1) The basic match score may be computed as a function of the known/predicted user-destination affinity and the level of keyword match; and (2) The boosted match score may also include a “boost” component computed from a destination status. Destinations may be sorted separately by the boosted score in order to determine which promotional/sponsored recommendations will be displayed.

In some embodiments, the level of keyword match may be measured as the ratio of keywords matched for a given destination. For example, a search for keywords “bar,” “country,” and “dancing” will have a match value of ⅔ with a destination with keywords “bar” and “dancing” but not “country.” In one exemplary embodiment, formally, let K_{DN} be the keywords associated with destination DN. For a search over keyword set K,

$$match ( DN , K ) = \frac{\vert K ⋂ {K}_{DN} \vert}{\vert K \vert} .$$

“Match” is a relevance function (i.e. the more relevant Items are to keywords, the higher “match” becomes.) In one exemplary embodiment, the example function shown above may be most appropriate for a use case where keywords are only chosen from a pre-defined list of options.

In other embodiments, users may freely enter arbitrary keywords. In this sort of use case, scoring (and the “match” logic) may be implemented through a specialized document store (e.g., Solr, Lucene, Elasticsearch.). The Items may be stored into these systems as documents, and these systems may then handle indexing in a way that efficiently allows whatever custom “match” is used for controlling relevance.

In some embodiments, use of a pre-defined list may be thought of as less risky than allowing unrestricted keyword entry. To mitigate risk factors in a scalable manner, the specialized document store discussed above may be implemented. That is, the operations necessary at query time may place stronger indexing demands on the system, and conventional relational database indexes may be less optimal.

Various risks for unrestricted keyword search may be classified as polysemy and synonymy—and each of these risk factors may be mitigated with different strategies, which can be applied in any combination. Multiple strategies are described below, but one or ordinary skill would appreciate that the list is non-exhaustive and other strategies may be implemented.

Polysemy may be described as a method or process for determining/identifying how to point a single keyword (e.g., “Italian”) to different Items based on the different meanings of the keyword.

For example, if a search is performed for “Italian food”, the original example match function gives equal relevance to three different items: one tagged “Italian cuisine”, another tagged “Italian movie”, and a third tagged “Mexican food.” While only the first item is what the user may be searching for and the other two are not relevant, the above-described embodiments do not distinguish that “Italian movie” isn't “Italian food”, which is an example of polysemy.

To solve this, metadata may be included with, for example, ambiguous keywords like “Italian”—a categorical label such as: Italian:restaurant, Italian:food, or the like. This metadata may give the information needed to solve for polysemy due to the term “Italian”, because in this embodiment, a match can count matches by categories, not just by tags.

In another exemplary embodiment, a way to handle the synonymy between “cuisine” and “food” may be added (which shouldn't be counted as different terms, even though they're unequal strings.)

Synonymy may be described as a method or process for determining/identifying how to guide keyword searches towards Items, even when the keywords (e.g., input by a user) do not exactly match the Item's tags. That is, a user should find a dance studio tagged “dancing” if the user searches for “dance”. The correlation/relationship may be determined by looking at the words themselves (without requiring the system knows what the words mean.) Other examples of synonymy may require a way to acknowledge relations between the meaning of words (“Italian cuisine” should be interchangeable with “Italian food” because “cuisine” is synonymous with “food” in this context.)

Stemming and fuzzy matching are relatively inexpensive options which may be used to handle matching between words which share common grammatical structure (e.g., “dances” and “dancing” have endings which suggest they can be stemmed equivalently to dance, so that all three terms become interchangeable to users when searching for tagged Items.

Synonym files may be utilized and may acknowledge relations of meaning that are not indicated by word structure (such as the relation between “cuisine” and “food”.) Items may be tagged initially, and the synonym files may provide a way for making these tags interchangeable with the actual keywords users eventually search; this simplifies the process of tagging Items and provides a basic way to handle complex synonymy. Additionally, unknown user keywords may be classified as related to known Item tags, by inferring a model of folksonomy based on user search history, known affinities, item similarity, and other models established elsewhere. The specifics of such a model exist outside the scope of this invention, though one or ordinary skill would appreciate that such a model may be used to generate a synonym file, which may then be treated as any other synonym file for the purposes of the present invention.

Context comparison (e.g., do “dance” and “dancing” have co-occurrence with any uncommon words, like “studio”, in some reference corpus?) and Semantic scoring functions (e.g., normalized compression distance) may also be utilized.

For the basic score, the relative importance of keyword match versus affinity may be governed by a weighting parameter W_{key}ε[0,1]. A higher value of the weighting parameter places more emphasis on the keyword match. For a search over keywords K by user ST, the basic match score list may be computed as follows:
1) Select Destinations DN with |K∩K_{DN}|>0.
2) Compute an overall score for each selected Destination DN as:

score(ST,DN,K)=W_{key}*match(DN,K)+(1−W_{key})*aff(ST,DN).
3) Sort Destinations by score in descending order and return the first n list elements (maintaining order), where n is the number of recommendations requested.

a) If W_{key}=0 then order first by affinity and use keyword match as a tiebreaker.

b) If W_{key}=1 then order first by keyword match and use affinity as a tiebreaker.

The boosted score may also incorporate a boosting factor. The boosting factor may be computed as:

boost(DN)=W_{b}*status(DN)^{p}

where status (DN) is the status of Destination DN and p is a configurable parameter with 0<p≦1 (default value 0.5) and W_{b}>0 is a configurable weighting parameter.

In some embodiments, only destinations with status (DN)>S for configurable threshold S are eligible for inclusion on the list of promoted destinations. The boosted match score list may be computed as follows:
1) Select Destinations DN with |K∩K_{DN}|>0 and with status (DN)>S.
2) Compute a boosted score for each selected DN as:

score_{boost}(ST,DN,K)=score(ST,DN,K)+boost(DN).
3) Sort Destinations by score in descending order and return the first m elements (maintaining order), where m is the number of boosted recommendations requested.

a) If W_{b}=0 then order first by basic score and use boost as a tie-breaker.

In some embodiments, Advertisements compete for impressions, clicks, and other events (“advertisement opportunities”) which only occur every so often. Scarcity creates a market for these opportunities. This market can be implemented through auctioning the opportunities to the highest bidder, with relevance adjustments made based on keyword matching and/or affinity.

In some embodiments, generalized second-price bidding may be used to auction off the opportunities. Advertisers may create their advertisement, and define a start date and end date indicating how long they want to run the ad. The advertiser may also assign a budget indicating an amount of money (e.g., a maximum, a minimum, or the like) they are willing to pay during the ad's lifetime. The aggressiveness of the advertisement is controllable by the maximum bid indicating the highest price the advertiser is willing to pay to win whatever event is being auctioned (For example, this may the maximum price the system will ever charge the advertiser per click, impression, etc. for this particular advertisement.)

When it comes time for search results to field ad placement, the same kind of boost factor used for destinations can be defined for advertisements. The boost applied to advertisements should depend on the maximum bid, if nothing else:

boost(AD)=bidₘₐₓ

To help facilitate more honest bidding, the boost function may include a scheduling factor:

boost(AD)=bidₘₐₓ*scheduling(AD)

The purpose of scheduling function is to exhaust the budget at an even rate throughout the lifetime of the advertisement. This may be done by introducing feedback based on how much budget is getting spent, versus how much time remains:

$$scheduling ( AD ) = \frac{{progress}_{time} ( AD ) + L}{{progress}_{budget} ( AD ) + L}$$

In this example, L is a smoothing constant, which acts to avoid division by zero without changing the intended bounds of the scheduling function (which ranges between 0 and 1 in this example.) The value of L may be between 0 and 1. The value of L may be determined experimentally.

A scheduling function equal to, for example, 1 means the budget is being spent at an appropriate rate. A scheduling function below 1 may then be indicative that the advertisement is too aggressive (e.g., winning too many auctions in too short a time.). The boost function drops, and the advertisement then spends less of the budget towards winning unlikely keywords or users. A scheduling function above 1 may then be indicative that the advertisement is not winning enough auctions, because, for example, the advertisement has not been defined aggressively enough. The advertisement may target a less relevant audience if it is to exhaust its budget within the configured duration.

In the short term, the effects of boosting may vary up and down due to the random appearance of opportunities—but in the long-run, the maximum bid will still have a constant effect on the boost. Meaning that, in some embodiments, (all else equal) the best shot of winning is by increasing your maximum bid.

$${progress}_{budget} ( AD ) = \frac{total\_spent ( AD )}{total\_budgeted ( AD )}$$

The amount of time remaining versus the total time budgeted to the advertisement may be another measure of progress. This may define the schedule (in the following example, it's presumed all advertisements want to exhaust their budgets evenly over the course of the ad):

$${progress}_{time} ( AD ) = \frac{now ( ) - starts ( AD )}{finishes ( AD ) - starts ( AD )}$$

### Real-Time Recommendations

In some embodiments, the system may request recommendations from the recommendation module in real time by supplying a user ST, a location ID LID, and a list of feasible advertisements (AID1, AID2, . . . ). The advertisement recommendation module may return the list of feasible advertisements in sorted order based on the known/predicted click rates.

Because the click rate of the advertisement may be normalized with respect to location, an overall ordering of active advertisements may be maintained for each user, and new requests may use this sorted list. For each user, the active ads may be sorted in descending order by known/predicted click rate with ties broken by sorting in ascending order by number of impressions with further ties broken randomly. (Note that randomly is not equivalent to arbitrarily—the tie breaker may be random so that one advertisement is not consistently favored over another by an arbitrary rule). When the system calls for a recommendation based on a list of the feasible advertisements, the recommendation module may use the overall stored ordering for the user to sort the list of feasible ads.

There may be business considerations for selecting advertisements that fall outside of the scope of the recommendation module. For example, new advertisements with no click data may not be ranked highly by the recommendation module until a predetermined threshold of clicks have been recorded. There may therefore be a need to favor new advertisements in order to, for example, satisfy contractual requirements and/or build up click rate data that can be used by the recommendation module.

### Exemplary Use Case for Utilizing Social Media Status System to Provide Real-Time Recommendations

In a social media setting, a user may be presented with a social status posting tool providing various optional social states such as “Looking to”, “Going”, “I'm Here”, “On the way”, “Hanging out”. These states are optionally selected to provide the user a way to broadcast their current social interests to those on an online network they are connected with. Additionally a user may be provided the ability to type text into a text box, add tags or hashtags for specific interests, neighborhoods, or locations (ex: Live Music, Craft Beer, Southside, #partytime, @Nightclub). For example a user may select “Looking to” then type in the text: Go out #uptown for some #livemusic and maybe head to @Nightclub. Alternatively, a user may not select a social state and may simple post: Who is down for an after work happy hour later today? In either event, the system may use the social state, and scan the text that is posted by a user, and also use the tags, locations, and hashtags entered to determine the current interest of the user then importantly weigh advertisements and recommendations that are displayed to match this determined interest until the user status changes. This method allows for real time recommendations and advertisements based a user's current state of mind and interest.

Data science proposition: A different boosting function may be associated for each different social state when ranking search results (depending which data features are relevant to that state). For example, “I'm here”, “on the way”, “going” may use a boosting function which emphasizes the geo-location of associated text; whereas “looking to” may use a boosting function which prioritizes the window of opportunity (start and end dates) on advertisements; whereas “hanging out” may influence result rankings based on the historical information of mentioned users.

Alternatively or additionally, the system may begin to weight advertisements and recommendations when the user selects a social state, but before they make the post. For example, once the user selects “Looking to”, the system recognizes the geographic area of the user via a profile city selection or GPS, and then presents advertisements based on the “looking to” selection, and behavioral knowledge of the user. This would then change once the user has posted, as the system then combines any text entered, along with any tags, as described above

### Adding any Additional Hypothetical Feature

The models above (i.e. the item-based similarity model, the user-based similarity model, and the global average model) each include a common example application, which assumes a hypothetical set of features. In some embodiments, if the features were different, the formulas associated with each may change.

One or more additional (i.e. other) hypothetical features may be added, for example, as long as the feature can be measured in the dimension of a User-User, Item-Item or User-Item Relation. Methods for modifying the above-disclosed embodiments, based on whichever hypothetical interactions might be added between Users and Items in the future are described herein. The hybrid User-based CF model can be tuned to achieve higher accuracy or coverage than a non-hybrid model on the same data; the same applies for the Item-based and GA models. By configuring each engine to different partitions of User space, the engine with the highest accuracy in the partition can be run for any User in that partition's region. The engine with the best performance in a region of User space may be configured to run for the Users in that region of User space. This helps efficiently covers more User space with better accuracy than running a single classifier to predict the same input data.

### Modifying the Above-Described Formulas to Account for Additional Features

As features are added, new kinds of contents and interaction become possible. The formulas used to model affinity/similarity may then change to account for these new Relations. The dimension of this Relation is measured by a data type, which determines the appropriate change needed in the formulas.

In some embodiments, the system may be configured to normalize the new dimension's measure. That is, dimensions may need to be normalized before they are combined into an Affinity or Similarity.

A plurality of strategies for Normalizing Binary Measures exist, some of which are described below.

Binary Relation=> include as an indicator term . . . .
(Binary User-User Relation)=> . . . in User Similarity in (as with gender.)
(Binary User-Item Relation)=> in Affinity (as with favorite destinations.)
(Binary Item-Item Relation)=> in Item Similarity (as with advertisement's Business ID.)

Relation between sets=> transform using set similarity . . . .
New disjoint set=> . . . concatenate with existing sets (as with a new interest category.)
New dependent set=> . . . requires a new pattern (explained later in this document.)

A plurality of strategies for Normalizing Continuous Measures exist, some of which are described below.

Bounded above AND below (such as ratings)=>
Linear Interpolation (“change of scale”)
Logarithmic transform=> as with estimated affinity [doc #60, section 191]

Bounded above OR below (such as counts)=> transform below a threshold
Horizontal asymptotic transform=> if you want diminishing returns, as with activations.
   Piecewise linear transform (“clamping”)=> if you don't want diminishing returns.

Unbounded=> transform into an upper and lower sub-function, bounded by the same value.

The system may then be configured to weight the normalized measure. When a new dimension is weighted against old dimensions, the system may be configured to fix the sum of weights before and after adding the new dimension. In other words, when a new dimension is added with a certain weight (relative to the existing dimensions), the system may be configured to: (1) Find the ratios between the original weights; (2) Reduce these weights proportionally; and (3) Continue until the deficit (from the old total) equals the desired weight of the new dimension.

Subsequent to weighting the normalized measure, it should be appreciated that the system may then utilize similar calculations as above, using modified formulas. The process for identifying which equation to modify is discussed below.

In some embodiments, the system may be configured to first combine behaviors with behaviors, separately combine content with content, and finally combine the total behavioral contribution to a total content-based contribution.

In one exemplary embodiment, if adding a new behavioral dimension, the equation for computed behavioral Affinity may be modified. The total weight of all dimensions would remain constant (e.g., 1).

In another exemplary embodiment, if adding a new content-based User dimension, the computed User Similarity may be modified (adjusting weights out of the original constant sum.)

In yet another exemplary embodiment, if adding a new content-based Item dimension, I'd modify the computed Item Similarity (adjusting weights out of the original constant sum.)

In some embodiments, while any of the above-identified equations may be modified, the above choices may be the most manageable. Note that the equations for Total Affinity and Total Similarity may be modified. However, the equations for Total Affinity and Total Similarity are not where new dimensions are intended to go. That is, while adding new dimensions (Relations) directly to this level of calculation is possible, it may not be the most sustainable approach (e.g., it makes it harder to measure achievement of the benefits claimed in particular embodiments of the present invention.)

### Exemplary Embodiment for Adding a New Dependent Set Dimension

Set similarity is used to compare how much two sets overlap, and is readily applied to features such as tags in a profile (or words in documents, etc.). In a list of possible items, which are either chosen or not chosen, set-similarity is a natural model for comparing records of such lists.

Some embodiments of the present invention include set similarity between user “interests” as part of the over-all User Similarity. Below is the socio-demographic component of User Similarity (taken from above).

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

A part of the equation calculates the set-similarity. These terms work to ensure that users become more/less similar based on how much their interests overlap.

Adding New Dimensions—Disjoint Sets

The above equation, which is described above stating that “the interest dimensions may be concatenated into a single list for each ST.” Interests can be broken down into sports, drinks, and various other lists of tags (which don't overlap.) Because none of the categories have overlapping options, a new category (or categories) may be added without changing the original equation, new disjoint dimension are concatenated with the existing disjoint dimensions.

Adding New Dimensions—Dependent Sets

The system may, in some embodiments, be configured to account for users disliking things other people are interested in. That is, “being different” is certainly a source of human preference and accordingly, the system may seek to avoid recommending a user to a tailgate for the wrong sports team. To help ensure this does not happen, a new dimension may be added which was dependent with interests—not a new category, but a second set of options covering the same items.

“Dislikes” isn't a category of “interests”—they share the same categories, and the same items in those categories. And “dislikes” and “interests” aren't disjoint—if the system already knows a user dislikes X, then it can be immediately known (or assumed) that the user is not interested in X.

As such, the original pattern (one set similarity, between two large, concatenated lists) will not work and the approach is modified. The modification maintains existing similarity properties, while capturing the disjoint information properly—and as such, changes may be restricted. For example, the changes may be restricted by the following:

As interests overlap, User Similarity increases.

As dislikes overlap, User Similarity increases.

As one user's interests overlap the other's dislikes, User Similarity decreases.

These three overlaps contribute to Similarity at equal rates.

The Similarity Relation remains symmetric.

The weight of the non-set-like dimensions should remain unchanged.

The simplest solution to these requirements is as follows:

|ST₁ interests∩ST₂ interests| becomes

$$\frac{1}{2} ( \vert {ST}_{1} interests ⋂ {ST}_{2} interests \vert + \vert {ST}_{1} dislikes ⋂ {ST}_{2} dislikes \vert - \vert {ST}_{1} interests ⋂ {ST}_{2} dislikes \vert - \vert {ST}_{1} dislikes ⋂ {ST}_{2} interests \vert )$$

$$\vert {ST}_{1} interests \vert becomes \frac{1}{2} ( \vert {ST}_{1} interests \vert + \vert {ST}_{1} dislikes \vert )$$

$$\vert {ST}_{2} interests \vert becomes \frac{1}{2} ( \vert {ST}_{2} interests \vert + \vert {ST}_{2} dislikes \vert )$$

As one or ordinary skill would appreciate that while this example is for adding “dislikes”, it could be applied for just as well if there were a dependent set dimension added to the firmographics for destinations, or any dependent set-like dimensions that might be added to ads, deals or other Items.

Note that the above example uses very precise definitions for the terms User and Item. That is, a user is only a “User” if the user satisfies the requirements of a User as defined by this document's “Definitions” section. If referring to users in general (whether or not they are also Users), the term “user” is used.

### DEFINITIONS/EXAMPLES

### Example 1

### An Individual User, Requesting Deals

### Example 2

### A Group of Users Planning a Night Out, Requesting Recommended Destinations

User—anything that can request recommendations. (e.g., the individual user, the group.)

Item—anything that can be recommended to a User. (e.g., deals, destinations, etc.)

Relation—Relations (e.g. “friendship”) are assigned to watch different actions (e.g. “adding a friend”, “removing a friend”). Relations can watch for behavioral signals, or content-based signals, or both (a Relation can be formed by combining simpler Relations, whether by joining in-database, or using a sub-function in the processor, and so on.)

Type—a thing's Type is what restricts the thing's available interactions. Users and Items aren't the same Type because “being an Item” doesn't guarantee you can request recommendations, whereas “being a User” always guarantees you can request recommendations.

A thing can have many Types—a user might be modeled as both a User and an Item, if destinations were able to request recommended patrons.

A Type can be generalized out of other, more specific Types—a “group” of users and an “individual” user are both Types of User (because both can receive recommendations). Even so, two “groups” cannot be friends the way two “individuals” can—making “groups” and “individuals” different Types (both within the same broader Type, User.)

User-User Relation—a Relation that records signs of User similarity. (e.g. ‘friendship’)

User-Item Relation—a Relation that records signs of affinity. (e.g. ‘activating’)

Item-Item Relation—a Relation that records signs of Item similarity (e.g. favorited by the same users?′).

### Exemplary Process for Programmatically Decreasing of the Relative Importance of the Content-Based Data, as Behavioral Data that May be Used for Collaborative Filtering Increases

As described above, the present invention is directed to a method of combining traditional collaborative filtering with content-based data, thereby creating a hybrid recommendation algorithm that programmatically decreases the relative importance of the content-based data, as affinity or preference data that may be used for collaborative filtering increases. As such, a calculated similarity metric may be configured to weigh evidence in a way that favors the affinity or preference data to a degree proportional to the behavioral data's relative availability or intensity to content based data.

Some embodiments of the present invention provide functionality enabling a combination of content-based data with users' affinities for items into a single hybrid content-based/CF recommendation engine such that the importance of each of component is not fixed, thus allowing the model to account for variation in the quantity and intensity of evidence, such as affinity data or preference data, supporting the CF model.

Specifically, as described earlier in reference to FIGS. 2A, 3A, and 3B, the item-based collaborative filtering model and the user based collaborative filtering models each may be configured to calculate a similarity metric. For example, the item-based collaborative filtering model may be configured to calculate a similarity metric between two destinations as shown in FIG. 2A and the user-based collaborative filtering models may be configured to calculate a similarity metric between two users as shown in FIGS. 3A, and 3B.

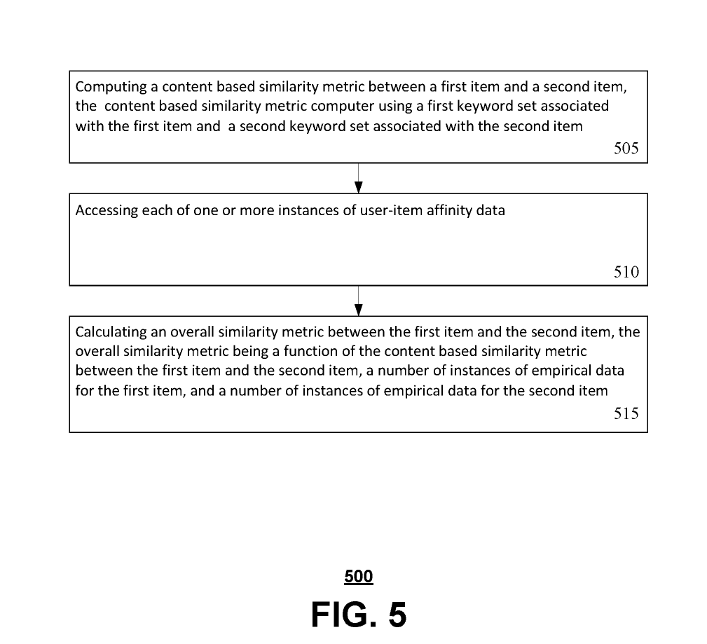

Accordingly, FIG. 5 is a flowchart illustrating an example method that may be performed by the recommendation module, in accordance with some example embodiments described herein. As is shown in operation 505, an apparatus, such as computing system 500, may include means, such as the item-based collaborative filtering module 110, the processor 703, or the like, for computing a content based similarity metric between a first item and a second item. In some embodiments, the content based similarity metric may be computed using a first keyword set associated with the first item and a second keyword set associated with the second item.

In some embodiments, the computing of the content based similarity between the first item and the second item may be defined as the number of common keywords between keywords associated with first item and keywords associated with the second item divided by the square root of the product of the number of keywords in each item profile. For example, content-based similarity between items a and b with keyword sets Kₐ and K_{b} may be defined as sim_{c}(a, b)=|Kₐ∩K_{b}|/√(|Kₐ|·|K_{b}|) where the vertical bars represent the set-size operation. In some embodiments, if either item lacks keywords, set sim_{c}(a, b) to zero. In some embodiments, the value of this function is bounded above by one and below by zero.

For example, in an embodiment in which the item is a destination, and the computing of the content based similarity metric may be a firmographic similarity between the first destination and the second destination. Moreover, the calculating of the content based similarity metric between the first destination and the second destination may be the number of common tags and/or categories between the those found in each destination's profile, for example between the destination and the second destination and subsequently divided by the square root of the product of the number of tags in each destination's profile.

As is shown in operation 510, an apparatus, such as computing system 500, may include means, such as the item-based collaborative filtering module 110, the user-based collaborative filtering module 112 and/or the global average module 114, the processor 703, or the like, for accessing each of one or more instances of user-item affinity data. Once the affinity data is available, as is shown in operation 510, an apparatus, such as computing system 500, may include means, such as the item-based collaborative filtering module 110, the user-based collaborative filtering module 112, the processor 703, or the like, for calculating an overall similarity metric between the first item and the second item. In some embodiments, the overall similarity metric may be a function of the content based similarity metric between the first item and the second item, a number of instances of empirical data for the first item, and a number of instances empirical data for the second item. As described above, empirical data may include both expressed and computed affinities, which may be derived directly from behavioral data relevant to estimating a user's preferences.

In some embodiments, the apparatus may be further configured such that the overall similarity metric is computer as a function of a non-negative weight, the non-negative weight being a configurable parameter identifying the rate at which the empirical data contribution increases relative to the content based similarity metric.

As described with reference to FIG. 2A, and specifically the destination similarity model, the apparatus may be further configure for defining V_{DN}_{₁} and V_{DN}_{₂} to be a vector of user-destination affinities across each of one or more users in a given set for the first item and the second destination, respectively, and the overall similarity metric may be calculated according to

$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} )\end{matrix} ) + {V}_{{DN}_{1}} \cdot {V}_{{DN}_{2}}}{\sqrt{3 {W}_{f} + {Σ}_{ST} ( {aff ( ST , {DN}_{1} )}^{2} )} * \sqrt{3 {W}_{f} + {Σ}_{ST} ( {aff ( ST , {DN}_{2} )}^{2} )}}$$

As can be appreciated based on the description above, as the number of expressed and computed (empirical) affinities grows for the first item and/or the second item (e.g., DN1 and/or DN2), the length of the affinity vectors and thus the denominator of sim(DN₁, DN₂) may increase. Moreover, the contribution of the content-based data (e.g., firmographic) variables to the numerator has a fixed maximum (each sub-function is between zero and 1). As such, the influence of content-based data similarity will decrease as the length of the two vectors increases. This may programmatically adjust the relative influence from content-based data similarity to affinity similarity as the number of empirical affinities for a destination increases.

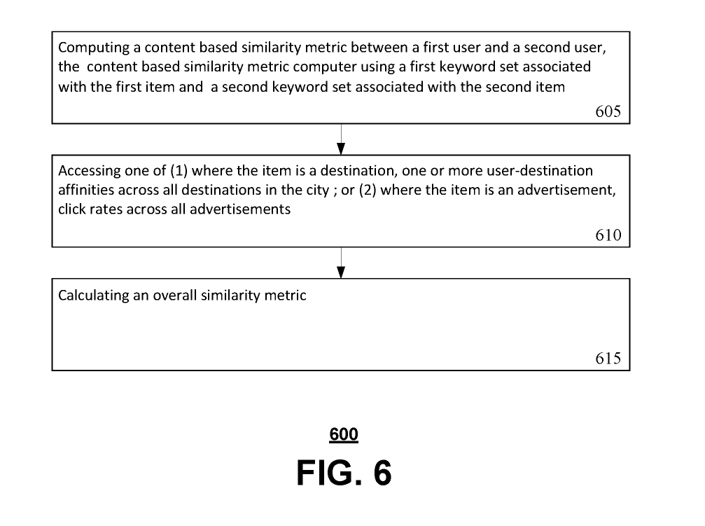

Similarly, an overall similarity metric between users may be calculated by user based collaborative filtering models, such as those described with reference to FIGS. 3A and 3B. The math for user similarity is analogous to that described above for item similarity. FIG. 6 is a flowchart illustrating an example method that may be performed by the recommendation module, specifically user-based collaborative filtering models stored therein, in accordance with some example embodiments described herein. As is shown in operation 605, an apparatus, such as computing system 500, may include means, such as the user-based collaborative filtering module 110, the processor 703, or the like, for computing a socio-demographic similarity between a first user and a second user. In some embodiments, socio-demographic similarity may be a function of demographics; age gender; drink(s) of choice; sport interest(s); favorite music; favorite food(s); favorite travel destinations(s); hobbies/interests; personal style(s); favorite destination(s), etc.

In some embodiments, as described above, the interest dimensions may be concatenated into a single list for each ST. And subsequently, the socio-demographic similarity between ST1 and ST2 may then be computed as:

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

As is shown in operation 610, an apparatus, such as computing system 500, may include means, such as the user-based collaborative filtering module 110, the processor 703, or the like, for accessing one of (1) where the item is a destination, one or more user-destination affinities across all destinations in the city; or (2) in an instance in which the item is an advertisement, click rates across all advertisements. In some embodiments, the apparatus may be configured for defining vectors identifying the behavioral data.

In an exemplary embodiment, the apparatus may be configured for, where the item is a destination, defining V_{DN}_{₁} and V_{DN}_{₂} to be a vector of user-destination affinities across each of one or more users in a given set for the first item and the second destination, respectively. If the affinity is null (i.e., unknown) then the corresponding element of the vector may be set to zero In other embodiments, such as where the item is an advertisement, the apparatus may be configured for defining V_{ST}_{₁} and V_{ST}_{₂} be a vector of user-advertisement click rates across one or more advertisements in a given set for the first user and the second user, respectively. If the click rate for a given (ST,AID) pair is null (i.e., unknown) then the corresponding element of the vector may be set to zero.

Once the socio-demographic similarities and the affinity data are available, the overall similarity may be computed. As is shown in operation 605, an apparatus, such as computing system 500, may include means, such as the user-based collaborative filtering module 110, the processor 703, or the like, for calculating an overall similarity metric. In one embodiment, such as where the item is a destination, the overall similarity metric may be defined as

$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} )\end{matrix} ) + {V}_{{DN}_{1}} \cdot {V}_{{DN}_{2}}}{\sqrt{3 {W}_{f} + {Σ}_{ST} ( {aff ( ST , {DN}_{1} )}^{2} )} * \sqrt{3 {W}_{f} + {Σ}_{ST} ( {aff ( ST , {DN}_{2} )}^{2} )}}$$

In another embodiment, such as where the item is an advertisement, the overall similarity metric may be defined as:

$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{AID} ( {\overline{rate} ( {ST}_{1} , AID )}^{2} )} * \sqrt{{W}_{sd} + {Σ}_{AID} ( {\overline{rate} ( {ST}_{2} , AID )}^{2} )}} .$$

As described earlier, as was the case for the destination similarity model, the user similarity model may programmatically adjust weight toward the affinity component of the similarity as more affinity data relevant to a user's preferences become known for either user. Similarly, the user similarity model may programmatically adjust weight toward the click rate component of the similarity as more click rates become known for either user.

Non-negative weight W_{sd} is a configurable parameter that can adjust the rate at which the affinity and/or click rate similarity gains influence over the socio-demographic similarity. Higher values of W_{sd} put greater weight on the sociodemographic similarity components, which means that a higher number of empirical affinities are required to reach a similar balance between socio-demographic and affinity-based similarity and/or click-based similarity as for a lower value of W_{sd}.

### Exemplary Apparatus

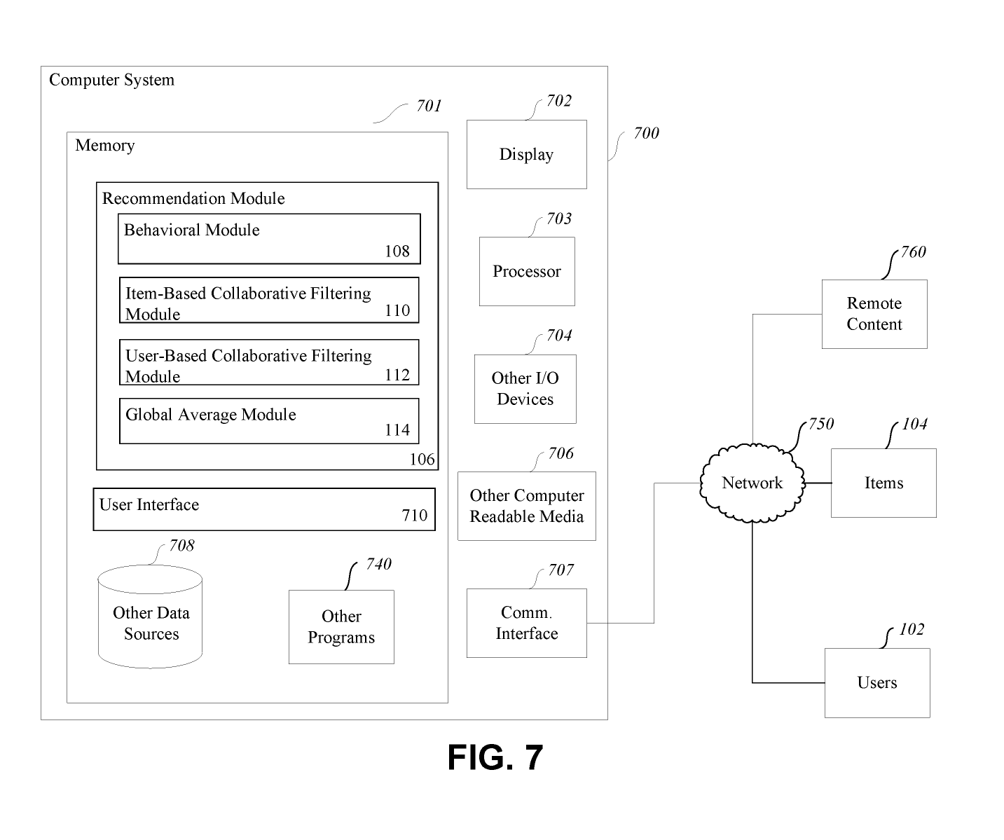

FIG. 7 is an example block diagram of an example computing device for practicing embodiments of an example recommendation module. In particular, FIG. 7 shows a computing system 700 that may be utilized to implement a social media environment 100 having a recommendation module 106 including, in some examples, behavioral model 108, item-based collaborative filtering module 110, a user-based collaborative filtering module 112 and/or a global average module 114 and/or a user interface 710. One or more general purpose or special purpose computing systems/devices may be used to implement the recommendation module 106 and/or the user interface 710. In addition, the computing system 700 may comprise one or more distinct computing systems/devices and may span distributed locations. In some example embodiments, the recommendation module 106 may be configured to operate remotely via the network 750, such that one or more client devices may access the recommendation module 106 via an application, webpage or the like. In other example embodiments, a pre-processing module or other module that requires heavy computational load may be configured to perform that computational load and thus may be on a remote device or server. For example, the behavioral model 108, the item-based collaborative filtering module 110, the user-based collaborative filtering module 112 and/or the global average module 114 may be accessed remotely. In other example embodiments, a user device may be configured to operate or otherwise access the recommendation module 106. Furthermore, each block shown may represent one or more such blocks as appropriate to a specific example embodiment. In some cases one or more of the blocks may be combined with other blocks. Also, the recommendation module 106 may be implemented in software, hardware, firmware, or in some combination to achieve the capabilities described herein.

In the example embodiment shown, computing system 700 comprises a computer memory (“memory”) 701, a display 702, one or more processors 703, input/output devices 704 (e.g., keyboard, mouse, CRT or LCD display, touch screen, gesture sensing device and/or the like), other computer-readable media 706, and communications interface 707. The processor 703 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application-specific integrated circuit (ASIC) or field-programmable gate array (FPGA), or some combination thereof. Accordingly, although illustrated in FIG. 7 as a single processor, in some embodiments the processor 703 comprises a plurality of processors. The plurality of processors may be in operative communication with each other and may be collectively configured to perform one or more functionalities of the recommendation module as described herein.

The recommendation module 106 is shown residing in memory 701. The memory 701 may comprise, for example, transitory and/or non-transitory memory, such as volatile memory, non-volatile memory, or some combination thereof. Although illustrated in FIG. 7 as a single memory, the memory 701 may comprise a plurality of memories. The plurality of memories may be embodied on a single computing device or may be distributed across a plurality of computing devices collectively configured to function as the recommendation module. In various example embodiments, the memory 701 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some examples, the recommendation module 106 may be stored remotely, such that it resides in a “cloud.”

In other embodiments, some portion of the contents, some or all of the components of the recommendation module 106 may be stored on and/or transmitted over the other computer-readable media 706. The components of the recommendation module 106 preferably execute on one or more processors 703 and are configured to enable operation of a recommendation module, as described herein.

Alternatively or additionally, other code or programs 740 (e.g., an administrative interface, one or more application programming interface, a Web server, and the like) and potentially other data repositories, such as other data sources 708, also reside in the memory 701, and preferably execute on one or more processors 703. Of note, one or more of the components in FIG. 7 may not be present in any specific implementation. For example, some embodiments may not provide other computer readable media 706 or a display 702.

The recommendation module 106 is further configured to provide functions such as those described with reference to FIGS. 2A, 2B, 3A, 3B, 4A, 4B, 5, and 6. The recommendation module 106 may interact with the network 750, via the communications interface 707, with remote content 760, such as third-party content providers, and one or more client devices operated by users 102. The network 750 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX, Bluetooth) that facilitate communication between remotely situated humans and/or devices. In some instances, the network 750 may take the form of the internet or may be embodied by a cellular network such as an LTE based network. In this regard, the communications interface 707 may be capable of operating with one or more air interface standards, communication protocols, modulation types, access types, and/or the like. Client devices include, but are not limited to, desktop computing systems, notebook computers, mobile phones, smart phones, personal digital assistants, tablets and/or the like. In some example embodiments, a client device may embody some or all of computing system 700.

In an example embodiment, components/modules of the recommendation module 106 are implemented using standard programming techniques. For example, the recommendation module 106 may be implemented as a “native” executable running on the processor 703, along with one or more static or dynamic libraries. In other embodiments, the recommendation module 106 may be implemented as instructions processed by a virtual machine that executes as one of the other programs 740. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use synchronous or asynchronous client-server computing techniques. Also, the various components may be implemented using more monolithic programming techniques, for example, as an executable running on a single processor computer system, or alternatively decomposed using a variety of structuring techniques, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the recommendation module 106, such as by using one or more application programming interfaces can be made available by mechanisms such as through application programming interfaces (API) (e.g., C, C++, C#, and Java); libraries for accessing files, databases, or other data repositories; through scripting languages such as XML; or through Web servers, FTP servers, or other types of servers providing access to stored data. The data sources 708 may be implemented as one or more database systems, file systems, or any other technique for storing such information, or any combination of the above, including implementations using distributed computing techniques and may provide relevant data to the behavioral model 108, the item-based collaborative filtering module 110, the user-based collaborative filtering module 112 and/or the global average module 114. Alternatively or additionally, the behavioral model 108, the item-based collaborative filtering module 110, the user-based collaborative filtering module 112 and/or the global average module 114 may have access to local data stores but may also be configured to access data from one or more remote data sources.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the recommendation module 106 may be implemented or provided in other manners, such as at least partially in firmware and/or hardware, including, but not limited to one or more ASICs, standard integrated circuits, controllers executing appropriate instructions, and including microcontrollers and/or embedded controllers, FPGAs, complex programmable logic devices (“CPLDs”), and the like. Some or all of the system components and/or data structures may also be stored as contents (e.g., as executable or other machine-readable software instructions or structured data) on a computer-readable medium so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

FIGS. 2A, 2B, 3A, 3B, 4A, 4B, 5, and 6. illustrate example flowcharts of the operations performed by an apparatus, such as computing system 700 of FIG. 7, in accordance with example embodiments of the present invention. It will be understood that each block of the flowcharts, and combinations of blocks in the flowcharts, may be implemented by various means, such as hardware, firmware, one or more processors, circuitry and/or other devices associated with execution of software including one or more computer program instructions. For example, one or more of the procedures described above may be embodied by computer program instructions. In this regard, the computer program instructions which embody the procedures described above may be stored by a memory 701 of an apparatus employing an embodiment of the present invention and executed by a processor 703 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 2A, 2B, 3A, 3B, 4A, 4B, 5, and 6, when executed, convert a computer or processing circuitry into a particular machine configured to perform an example embodiment of the present invention. Accordingly, the operations of FIGS. 2A, 2B, 3A, 3B, 4A, 4B, 5, and 6 define an algorithm for configuring a computer or processor, to perform an example embodiment. In some cases, a general purpose computer may be provided with an instance of the processor which performs the algorithm of FIGS. 2A, 2B, 3A, 3B, 4A, 4B, 5, and 6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some example embodiments, certain ones of the operations herein may be modified or further amplified as described herein. Moreover, in some embodiments additional optional operations may also be included. It should be appreciated that each of the modifications, optional additions or amplifications described herein may be included with the operations herein either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for combining collaborative filtering with content-based data thereby creating a hybrid recommendation algorithm that programmatically decreases the importance of the content-based data as the basis of affinity data supporting collaborative filtering grows over time, the method comprising:
computing a content based similarity metric between a first item and a second item, the content based similarity metric computer using a first keyword set associated with the first item and a second keyword set associated with the second item;
accessing each of one or more instances of affinity data; and
calculating an overall similarity metric between the first item and the second item, the overall similarity metric being a function of the content based similarity metric between the first item and the second item, a number of instances of empirical data for the first item, and a number of instances of empirical data for the second item,
the function defined such that a contribution of the content based similarity metric having a fixed maximum, and as the number of instances of empirical data for the first item or the number of instances of empirical data for second item increases, the overall similarity metric increasing a relative contribution in favor of the empirical data.

2. The method according to claim 1, wherein the computing of the content based similarity between the first item and the second item is defined as the number of common keywords between keywords associated with first item and keywords associated with the second item divided by the square root of the product of the number of keywords in each item profile.

3. The method according to claim 1, wherein the overall similarity metric further being a function of a non-negative weight, the non-negative weight being a configurable parameter that can adjust the rate at which the empirical data contribution increases relative to the content based similarity metric.

4. The method according to claim 1, wherein the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile.

5. The method according to claim 1, wherein the item is a destination, and the method further comprising:
defining V_{DN}_{₁} and V_{DN}_{₂} to be a vector of user-destination affinities across each of one or more users in a given set for the first item and the second destination, respectively; and
the overall similarity metric is calculated according to:
$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} )\end{matrix} ) + {V}_{{DN}_{1}} \cdot {V}_{{DN}_{2}}}{\sqrt{3 {W}_{f} + {Σ}_{ST} ( {aff ( ST , {DN}_{1} )}^{2} )} * \sqrt{3 {W}_{f} + {Σ}_{ST} ( {aff ( ST , {DN}_{2} )}^{2} )}}$$

6. The method according to claim 4, wherein the overall similarity metric further being a function of a non-negative weight, the non-negative weight being a configurable parameter that can adjust the rate at which the affinity similarity contribution increases relative to the firmographic similarity.

7. The method according to claim 1, wherein the computing of the content based similarity metric is a socio-demographic similarity between a first user and a second user,
the content based similarity metric computed as a function of one or more socio-demographic variables.

8. The method according to claim 1, wherein the item is an advertisement, the method further comprising:
defining V_{ST}_{₁} and V_{ST}_{₂} be a vector of user-advertisement click rates across one or more advertisements in a given set for the first user and the second user, respectively;
the overall similarity metric is calculated according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{AID} ( {\overline{rate} ( {ST}_{1} , AID )}^{2} )} * \sqrt{{W}_{sd} + {Σ}_{AID} ( {\overline{rate} ( {ST}_{2} , AID )}^{2} )}} .$$

9. The method according to claim 4, wherein the overall similarity metric further being a function of a non-negative weight, the non-negative weight being a configurable parameter that can adjust the rate at which the click rate similarity contribution increases relative to the socio-demographic similarity.

10. The method according to claim 1, wherein the item is a destination, the method further comprising:
defining V_{ST}_{₁} and V_{ST}_{₂} be a vector of user-destination affinities across one or more destinations in a given set for the first user and the second user, respectively; and
the overall similarity metric is calculated according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{DN} ( {aff ( {ST}_{1} , DN )}^{2} )} * \sqrt{{W}_{sd} + {Σ}_{DN} ( {aff ( {ST}_{2} , DN )}^{2} )}} .$$

11. An apparatus for combining collaborative filtering with content-based data thereby creating a hybrid recommendation algorithm that programmatically decreases the importance of the content-based data as the basis of affinity data supporting collaborative filtering grows over time, the apparatus comprising:
a processor including one or more processing devices configured to perform independently or in tandem to execute hard-coded functions or execute software instructions;
a user interface;
a communications module; and
a memory comprising one or more volatile or non-volatile electronic storage devices storing computer-readable instructions configured to programmatically update budgeting data, target consumer profile data, and promotion component data, the computer-readable instructions being configured, when executed, to cause the processor to:
compute a content based similarity metric between a first item and a second item, the content based similarity metric computer using a first keyword set associated with the first item and a second keyword set associated with the second item;
access each of one or more instances of affinity data; and
calculate an overall similarity metric between the first item and the second item, the overall similarity metric being a function of the content based similarity metric between the first item and the second item, a number of instances of empirical data for the first item, and a number of instances of empirical data for the second item,
the function defined such that a contribution of the content based similarity metric having a fixed maximum, and as the number of instances of empirical data for the first item or the number of instances of empirical data for second item increases, the overall similarity metric increasing a relative contribution in favor of the empirical data.

12. The apparatus of claim 11, wherein the computing of the content based similarity between the first item and the second item is defined as the number of common keywords between keywords associated with first item and keywords associated with the second item divided by the square root of the product of the number of keywords in each item profile.

13. The apparatus of claim 11, wherein the overall similarity metric further being a function of a non-negative weight, the non-negative weight being a configurable parameter that can adjust the rate at which the empirical data contribution increases relative to the content based similarity metric.

14. The apparatus of claim 11, wherein the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile.

15. The apparatus of claim 11, wherein the item is a destination, and wherein the memory stores computer-readable instructions that, when executed, cause the processor to:
define V_{DN}_{₁} and V_{DN}_{₂} to be a vector of user-destination affinities across each of one or more users in a given set for the first item and the second destination, respectively; and
calculate the overall similarity metric according to:
$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} )\end{matrix} ) + {V}_{{DN}_{1}} \cdot {V}_{{DN}_{2}}}{\sqrt{3 {W}_{f} + {Σ}_{ST} ( {aff ( ST , {DN}_{1} )}^{2} )} * \sqrt{3 {W}_{f} + {Σ}_{ST} ( {aff ( ST , {DN}_{2} )}^{2} )}}$$

16. The apparatus of claim 14, wherein the overall similarity metric further being a function of a non-negative weight, the non-negative weight being a configurable parameter that can adjust the rate at which the affinity similarity contribution increases relative to the firmographic similarity.

17. The apparatus of claim 11, wherein the computing of the content based similarity metric is a socio-demographic similarity between a first user and a second user,
the content based similarity metric computed as a function of one or more socio-demographic variables.

18. The apparatus of claim 11, wherein the item is an advertisement, wherein the memory stores computer-readable instructions that, when executed, cause the processor to:
define V_{ST}_{₁} and V_{ST}_{₂} be a vector of user-advertisement click rates across one or more advertisements in a given set for the first user and the second user, respectively;
calculate the overall similarity metric according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{AID} ( {\overline{rate} ( {ST}_{1} , AID )}^{2} )} * \sqrt{{W}_{sd} + {Σ}_{AID} ( {\overline{rate} ( {ST}_{2} , AID )}^{2} )}} .$$

19. The apparatus of claim 14, wherein the overall similarity metric further being a function of a non-negative weight, the non-negative weight being a configurable parameter that can adjust the rate at which the click rate similarity contribution increases relative to the socio-demographic similarity.

20. The apparatus of claim 11, wherein the item is a destination, wherein the memory stores computer-readable instructions that, when executed, cause the processor to:
define V_{ST}_{₁} and V_{ST}_{₂} be a vector of user-destination affinities across one or more destinations in a given set for the first user and the second user, respectively; and
calculate the overall similarity metric according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{DN} ( {aff ( {ST}_{1} , DN )}^{2} )} * \sqrt{{W}_{sd} + {Σ}_{DN} ( {aff ( {ST}_{2} , DN )}^{2} )}} .$$

21. A computer program product configured for combining collaborative filtering with content-based data thereby creating a hybrid recommendation algorithm that programmatically decreases the importance of the content-based data as the basis of affinity data supporting collaborative filtering grows over time, the computer program product comprising at least one computer-readable storage medium having computer-executable program code instructions stored therein, the computer-executable program code instructions comprising program code instructions for:
computing a content based similarity metric between a first item and a second item, the content based similarity metric computer using a first keyword set associated with the first item and a second keyword set associated with the second item;
accessing each of one or more instances of affinity data; and
calculating an overall similarity metric between the first item and the second item, the overall similarity metric being a function of the content based similarity metric between the first item and the second item, a number of instances of empirical data for the first item, and a number of instances of empirical data for the second item,
the function defined such that a contribution of the content based similarity metric having a fixed maximum, and as the number of instances of empirical data for the first item or the number of instances of empirical data for second item increases, the overall similarity metric increasing a relative contribution in favor of the empirical data.

22. The computer program product according to claim 21, wherein the computer-executable program code instructions further comprise program code instructions for:
wherein the computing of the content based similarity between the first item and the second item is defined as the number of common keywords between keywords associated with first item and keywords associated with the second item divided by the square root of the product of the number of keywords in each item profile.

23. The computer program product according to claim 21, wherein the overall similarity metric further being a function of a non-negative weight, the non-negative weight being a configurable parameter that can adjust the rate at which the empirical data contribution increases relative to the content based similarity metric.

24. The computer program product according to claim 21, wherein the item is a destination, and the computing of the content based similarity metric is a firmographic similarity between the first destination and the second destination, the calculating the content based similarity metric between the first destination and the second destination being the number of common tags or categories between the first destination and the second destination divided by the square root of the product of the number of tags in each destination's profile.

25. The computer program product according to claim 21, wherein the item is a destination, and wherein the computer-executable program code instructions further comprise program code instructions for:
defining V_{DN}_{₁} and V_{DN}_{₂} to be a vector of user-destination affinities across each of one or more users in a given set for the first item and the second destination, respectively; and
calculating the overall similarity metric according to:
$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ {sim}_{nbd} ( {DN}_{1} , {DN}_{2} )\end{matrix} ) + {V}_{{DN}_{1}} \cdot {V}_{{DN}_{2}}}{\sqrt{3 {W}_{f} + {Σ}_{ST} ( {aff ( ST , {DN}_{1} )}^{2} )} * \sqrt{3 {W}_{f} + {Σ}_{ST} ( {aff ( ST , {DN}_{2} )}^{2} )}}$$

26. The computer program product according to claim 24, wherein the overall similarity metric further being a function of a non-negative weight, the non-negative weight being a configurable parameter that can adjust the rate at which the affinity similarity contribution increases relative to the firmographic similarity.

27. The computer program product according to claim 21, wherein the computing of the content based similarity metric is a socio-demographic similarity between a first user and a second user,
the content based similarity metric computed as a function of one or more socio-demographic variables.

28. The computer program product according to claim 21, wherein the item is an advertisement, wherein the computer-executable program code instructions further comprise program code instructions for:
defining V_{ST}_{₁} and V_{ST}_{₂} be a vector of user-advertisement click rates across one or more advertisements in a given set for the first user and the second user, respectively;
the overall similarity metric is calculated according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{AID} ( {\overline{rate} ( {ST}_{1} , AID )}^{2} )} * \sqrt{{W}_{sd} + {Σ}_{AID} ( {\overline{rate} ( {ST}_{2} , AID )}^{2} )}} .$$

29. The computer program product according to claim 24, wherein the overall similarity metric further being a function of a non-negative weight, the non-negative weight being a configurable parameter that can adjust the rate at which the click rate similarity contribution increases relative to the socio-demographic similarity.

30. The computer program product according to claim 21, wherein the item is a destination, wherein the computer-executable program code instructions further comprise program code instructions for:
defining V_{ST}_{₁} and V_{ST}_{₂} be a vector of user-destination affinities across one or more destinations in a given set for the first user and the second user, respectively; and
calculating the overall similarity metric according to:
$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {Σ}_{DN} ( {aff ( {ST}_{1} , DN )}^{2} )} * \sqrt{{W}_{sd} + {Σ}_{DN} ( {aff ( {ST}_{2} , DN )}^{2} )}} .$$
